(19) United States
(12) Patent Application Publication
(10) Pub. No.: US 2026/0220223 A1
(43) Pub. Date: Jul. 30, 2026

(54) DATA PROCESSING VIA PRIME COHERENCE

(71) Applicant: CODES Intelligence LLC, Boulder, CO (US)

(72) Inventor: Devin Bostick, Boulder, CO (US)

(21) Appl. No.: 19/559,732

(22) Filed: Mar. 6, 2026

Related U.S. Application Data
(63) Continuation of application No. 19/370,504, filed on Oct. 27, 2025.
(60) Provisional application No. 63/751,676, filed on Jan. 30, 2025.
(60) Provisional application No. 63/771,565, filed on Mar. 13, 2025.
(60) Provisional application No. 63/786,935, filed on Apr. 10, 2025.
(60) Provisional application No. 63/848,921, filed on Jul. 22, 2025.
(60) Provisional application No. 63/855,649, filed on Aug. 1, 2025.

(51) Int. Cl. G06F 17/14; G06F 5/01

(52) U.S. Cl. CPC G06F 17/148; G06F 17/11; G06N 20/00

(57) ABSTRACT

Inputs may be processed using coherence resonance peaks. This may include deriving one or more prime resonance anchors corresponding to an input waveform, using the one or more prime resonance anchors to generate one or more coherent peaks of a prime encoded resonance field for the input, and mapping the one or more coherent peaks to a result corresponding to the input.

### CROSS REFERENCE TO RELATED APPLICATIONS

This claims the benefit of, and is a continuation of U.S. non-provisional patent application Ser. No. 19/370,504, filed Oct. 27, 2025 for “Data Processing Via Prime Coherence,” which itself is a non-provisional of, and claims the benefit of U.S. provisional patent application 63/751,676, filed Jan. 30, 2025 for “Chirality of Dynamic Emergent Systems (CODES) Algorithm,” U.S. provisional patent application 63/771,565, filed Mar. 13, 2025 for “Artificial Intelligence Via Chirality of Dynamic Emergent Systems,” U.S. provisional patent application 63/786,935, filed Apr. 10, 2025 for “Resonance-Based structured Signal Processing and Coherence Computation System,” U.S. provisional patent application 63/848,921, filed Jul. 22, 2025 for “Phase-Gated User Interface and Symbolic Emission Control Layer for Deterministic Intelligence Systems,” and U.S. provisional patent application 63/855,649, filed Aug. 1, 2025 for “Data Processing via Prime Resonance.” The disclosures of each of the foregoing are hereby incorporated by reference in their entirety.

### BACKGROUND

Artificial intelligence (AI) has quickly transformed the way a wide range of tasks are performed, as models such as convolutional networks and transformers allow computers to do things which had, until recently, been seen as requiring human expertise. However, current artificial intelligence technology has a variety of downsides and limitations which not only undermine its current utility, but may ultimately impose costs which exceed the (admittedly significant) benefits that AI can provide. For example, training and operating current artificial intelligence models is tremendously calculation intensive, and is accompanied by concomitantly tremendous power generation and computing infrastructure needs. Accordingly, there is a need for improved technology which can improve one or more of these and/or other drawbacks of current approaches to implementing AI.

### SUMMARY

Aspects of this disclosure can be used to implement systems and methods which provide artificial intelligence (AI) functionality through phase-locking of prime resonance fields. This may include a method which comprises deriving one or more prime resonance anchors corresponding to an input waveform, using the one or more prime resonance anchors to generate one or more coherent peaks of a prime encoded resonance field for the input, and mapping the one or more coherent peaks to a result corresponding to the input. Corresponding systems and computer readable media may also be implemented based on this disclosure.

According to a first aspect, a method may be provided which comprises deriving one or more prime resonance anchors corresponding to an input waveform, using the one or more prime resonance anchors to generate one or more coherent peaks of a prime encoded resonance field, and providing a result based on the one or more coherent peaks.

In some examples, the method comprises: converting an input into a set of tokens; obtaining a set of waveforms, wherein the set of waveforms comprises a waveform for each token from the set of tokens; and combining the set of waveforms into a composite waveform; and the input waveform is the composite waveform.

In some examples, combining the set of waveforms into the composite waveform comprises generating a normalized sum of the set of waveforms.

In some examples, the method comprises obtaining the input waveform based on applying a frequency space transformation to a non-waveform input.

In some examples, the frequency space transformation is a Fourier transform.

In some examples, the non-waveform input is an embedding; and the frequency space transformation is harmonic principal projection.

In some examples, each of the one or more prime resonance anchors corresponds to a constituent waveform of the input waveform; and deriving one or more prime resonance anchors corresponding to the input waveform comprises, for each of the one or more prime resonance anchors, bring a phase difference between a prime waveform for that prime resonance anchor and the corresponding constituent waveform for that prime resonance anchor into conformity with a phase alignment threshold.

In some examples, using the one or more prime resonance anchors to generate one or more coherent peaks of the prime encoded resonance field comprises: bringing the prime encoded resonance field into a coherent state by iteratively adjusting a plurality of location specific values in that field; and identifying the one or more coherent peaks in the coherent state prime encoded resonance field.

In some examples, the plurality of location specific values comprises, for each prime resonance anchor from the one or more prime resonance anchors corresponding to the input waveform, a phase offset value for that anchor; and iteratively adjusting the plurality of location specific values comprises, on each iteration from a plurality of iterations, for each location specific value from the plurality of location specific values, adjusting that location specific value based on phase offset values for neighboring locations in the prime encoded resonance field.

In some examples, calculating, for each prime resonance anchor from a plurality of prime resonance anchors, a coherence value based on an adjusted location specific value corresponding to that prime resonance anchor; and identifying at least one of the plurality of prime resonance anchors as a coherent peak based on filtering the plurality of prime resonance anchors using the coherence values of the plurality of prime resonance anchors.

In some examples, each prime resonance anchor from the plurality of prime resonance anchors has a chirality value from a plurality of chirality values; and for each chirality value from the plurality of chirality values, the one or more coherent peaks of the prime encoded resonance field comprise a prime resonance anchor having that chirality value.

In some examples, generating one or more coherent peaks of the prime encoded resonance field comprises generating a plurality of coherent peaks; and providing the result based on the one or more coherent peaks comprises: obtaining an output waveform based on the plurality of coherent peaks; and converting the output waveform to the result.

In some examples, converting the output waveform to the result comprises obtaining the result from a lookup table using the output waveform.

In some examples, the method comprises: generating a plurality of partial results corresponding to the input waveform; and evaluating the plurality of partial results as a sequence of partial results.

In some examples, evaluating the plurality of partial results as a sequence comprises determining a phase alignment based on differences between phases for the partial results in the sequence of partial results and an average phase for the prime encoded resonance field.

In some examples, evaluating the plurality of partial results as a sequence comprises determining a weighted global emission score using a coherence weight and a phase for each of the plurality of partial results.

In some examples, the method comprises, for each partial result from the plurality of partial results, the coherence weight for that partial result is based on: a phase alignment between that partial result and neighboring values in the prime encoded resonance field; a historical alignment for that partial result; and structural harmony between that partial result and the prime encoded resonance field.

In some examples, evaluating the plurality of partial results as a sequence comprises applying a structural integrity filter based on, for each partial result from the plurality of partial results: a phase delta across adjacent partial results in the sequence; and a memory match coefficient for that partial result.

In some examples, the method comprises remediating the sequence of partial results by performing acts comprising re-performing the generation of one or more coherent peaks of the prime encoded resonance field.

In some examples, the input waveform is a waveform for a natural language prompt; and the result is a natural language response to the natural language prompt.

A variety of additional aspects will be set forth in the description that follows. These aspects can relate to individual features and to combinations of features. It is to be understood that both the foregoing summary and the following detailed description are exemplary and explanatory only and are not restrictive of the broad concepts upon which the embodiments disclosed herein are based.

### BRIEF DESCRIPTION OF THE DRAWINGS

While the specification concludes with claims which particularly point out and distinctly claim the invention, the present invention will be better understood from the following description of certain examples taken in conjunction with the accompanying drawings, in which like reference numerals identify the same elements and in which:

FIG. 1 illustrates a high level method which leverages prime resonance for data processing.

FIG. 2 illustrates a method which may be used to convert an input into an input waveform.

FIG. 3 illustrates a method which may be used to determine a phase offset.

FIG. 4 illustrates an example resonance field.

FIG. 5 illustrates a method which may be used to specify values in a prime encoded resonance field.

FIG. 6 illustrates a method which may be used to generate coherent peaks of a prime encoded resonance field.

FIG. 7 illustrates a method by which a resonance field's coherent peak(s) may be mapped to a data processing result.

FIG. 8 illustrates a method in which a sequence of potential outputs may be considered holistically in order to provide a more coherent result.

FIG. 9 illustrates a process for output sequence remediation.

FIG. 10 illustrates an exemplary computing apparatus which may be used in implementing the disclosed technology.

FIGS. 11A-11B illustrate a method of using aspects of the disclosed technology for quantum resonance pair encryption.

FIG. 12 illustrates a method which may be used in learning a mapping function.

FIG. 13 illustrates processing which may be used to define parameters of a resonance field.

FIG. 14 illustrates a method which may be used to determine if an anchor should have a subanchor.

FIG. 15 illustrates a method by which wavelet transforms may be used in peak filtration.

FIG. 16 illustrates a method which may be used in confirming that two sequences exhibit harmonic completeness.

FIG. 17 illustrates a potential organization which may be used in some implementations.

FIG. 18 illustrates an exemplary waveform simplification method.

FIG. 19 illustrates a sequence of filters which can be applied to determine output acceptability.

The drawings are not intended to limit the scope of the invention in any way, and it is contemplated that various embodiments of the invention may be carried out in a variety of other ways, including those not necessarily depicted in the drawings. The accompanying drawings, incorporated in and forming a part of the specification, illustrate several aspects of the present invention, and together with the description serve to explain the principles of the invention; it being understood, however, that this invention is not limited to the precise arrangements shown.

### DETAILED DESCRIPTION

Described herein is technology which may leverage prime resonance for improved performance of various data processing tasks, including artificial intelligence tasks such as natural language generation. The use of prime resonance may provide a variety of advantages relative to conventional approaches. For instance, in the context of artificial intelligence, some aspects of the disclosed technology may replace stochastic training with coherent phase locking, which may improve performance and/or decrease processing demands. Other benefits, both when the disclosed technology is applied in the context of artificial intelligence and for other applications, are also possible, and will be immediately apparent to those of skill in the art in light of this disclosure. Accordingly, while this disclosure provides examples in the context of artificial intelligence, it should be understood that those examples are intended to be illustrative only, and that they should not be treated as implying limits on the protection provided by this or any related document. Various embodiments of the disclosed technology may bridge symbolic inference, biological remediation, and/or structured hardware via a unifying resonance substrate, thereby removing randomness in, providing a concrete anchor for, and thereby improving the performance of, data processing across a variety of domains. Aspects of the disclosed technology may be used to implement an architecture which enables cross-domain generalization across software, silicon, and biospheric substrates, which may exceed the capabilities of existing stochastic artificial intelligence systems.

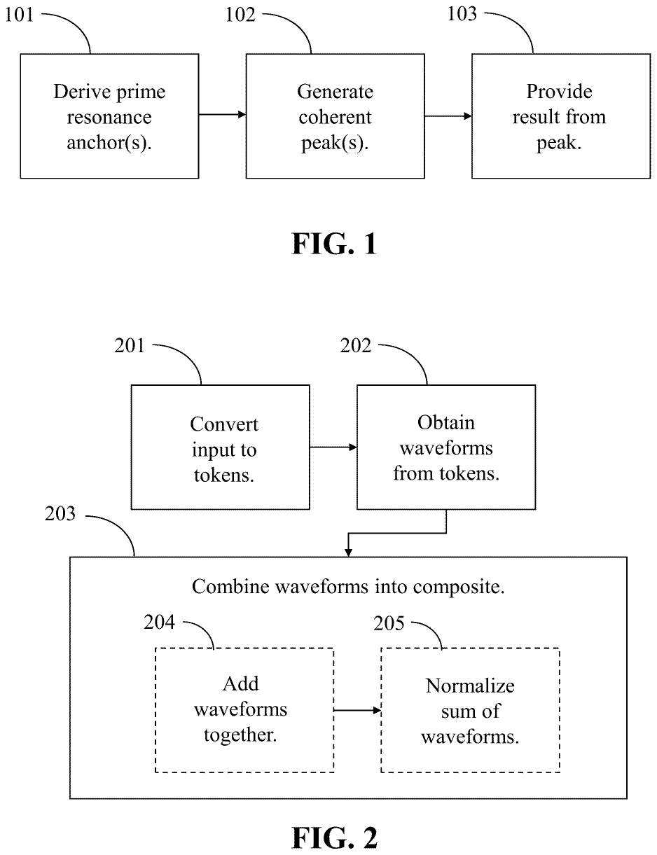

Turning now to the figures, FIG. 1 illustrates a high level method which leverages prime resonance for data processing. As shown in that figure, such a method may begin with deriving 101 one or more prime resonance anchors for an input waveform. This input waveform may take a variety of forms. For example, in some cases, a method such as shown in FIG. 1 may be used in a context where input would originally be provided as a waveform, such as if an implementation of the disclosed technology was used to analyze an audio recording or an electroencephalogram (EEG). However, in other cases, an input may be provided in other formats which may need to be converted into waveforms before they could be processed by a method such as shown in FIG. 1. An example of this would be a text representation of natural language speech. A method which may be used to convert such an input into an input waveform is illustrated in FIG. 2, discussed below.

As shown in FIG. 2, converting an input into an input waveform may begin by converting 201 the input into a set of tokens. In some cases, this may be done simply by extracting tokens which are already used to encode the input. For example, if the input is a natural language prompt such as “What is the meaning of life?” then it may be converted into tokens by extracting the discrete characters used to encode that prompt (e.g., ACSII or UTF-8 encodings of the characters in the string “What is the meaning of life?”). However, other approaches are also possible, and may be used in some cases. For example, in some cases a natural language prompt may be converted into n-gram level tokens (e.g., tokens for “the”, “ing”, and/or “is a”). As yet another approach, in some cases, an input (or a portion thereof) may be converted into an embedding, such as may be provided by a language model like BERT (as described in Devlin et al., Pre-training of Deep Bidirectional Transformers for Language Understanding, available at https://arxiv.org/abs/1810.04805, which is hereby incorporated by reference in its entirety), GloVe (as described in Pennington et al., Glove: Global Vectors for Word Representation, available at https://aclanthology.org/D14-1162/, which is hereby incorporated by reference in its entirety) or fastText (as described in Bojanowski et al., Enriching Word Vectors with Subword Information, available at https://arxiv.org/abs/1607.04606, which is hereby incorporated by reference in its entirety). Values of the embedding may then be used to convert the embedding dimensions into tokens (e.g., the top n % of the embedding dimensions may be converted into tokens, each embedding dimension with a value/absolute value greater than a threshold may be converted into a token, etc.) for the input.

However it is done, once the input has been converted 201 into tokens, the method of FIG. 2 continues with obtaining 202 a set of waveforms from those tokens. This may be done by assigning each of the tokens a prime index pₙ and then calculating a frequency for a sine wave corresponding to that token, such as using equation 1, below.

$${f}_{n} = A * ln ( {p}_{n} ) \qquad Equation 1$$

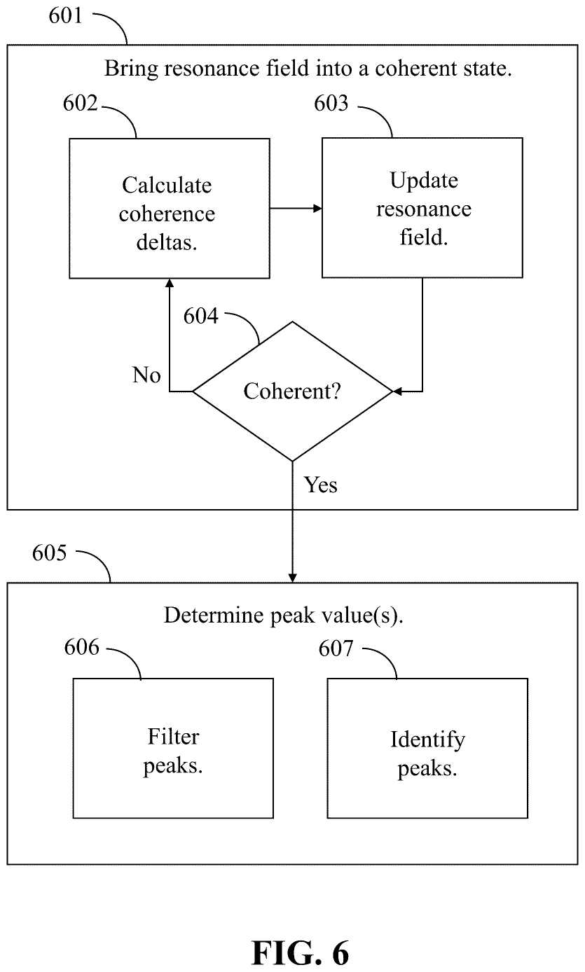

In that equation fₙ is the frequency of the sine wave corresponding to the n^{th} token, pₙ is the prime index of the nₜₕ token, and A is a system-level resonance scaling constant which may be assigned a default value such as 440 Hz. For instance, in the example of the input prompt “What is the meaning of life?” the first token in that prompt (e.g., ‘W’), may be assigned the prime index of 2 (i.e., the first prime number, corresponding to “W” being the first token in the prompt), and so, using the default value of 440 Hz for A, f₁=440*ln(2)≈305 Hz. Alternatively, for tokens whose frequencies are calculated after one or more previous inputs have been subjected to coherence processing such as that described herein, the resonance scaling constant may be assigned a value derived based on data generated during that processing. For example, in a case where the coherence processing results in scores reflecting the alignment of neighboring anchors in a resonance field (e.g., a global phase alignment score, as discussed in the context of FIG. 6) the resonance scaling constant may be scaled in proportion to that score. Similarly, in embodiments where coherence processing outputs are associated with weighted chirality values (e.g., as described in the context of FIG. 8), the resonance scaling constant may be adjusted according to the average chirality values of prior outputs. Similarly, in some cases, the resonance scaling constant may be modified based on other factors, such as in response to energy constraints (e.g., the resonance scaling constant could be decreased in response to energy constraints) and/or time sensitive coherence thresholds (e.g., the resonance scaling constant could be increased when there was a time sensitive threshold).

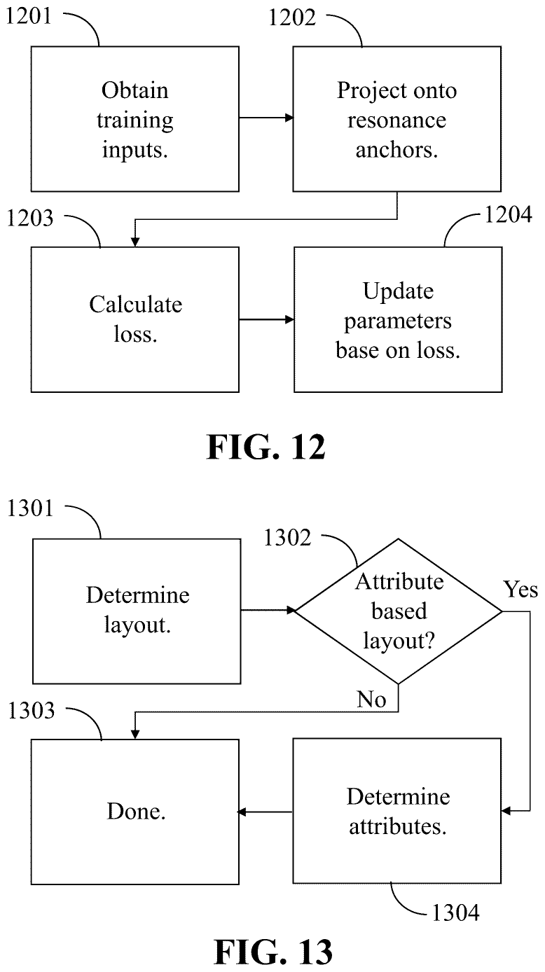

Other approaches are also possible. To illustrate, consider a case where converting 201 the input into tokens involves generating an embedding for the input. In such a case, rather than calculating the frequencies of sine waves using equation 1, an embedding for the input may be projected into frequency space using harmonic principal projection. This may map a semantic vector v into a frequency aligned vector fᵥ through a mapping function f(v), which may be learned using a method such as that shown in FIG. 12. To illustrate this method, consider a scenario in which the disclosed technology is used to implement a classifier which classifies images as either depicting dogs or not depicting dogs (i.e., a binary dog/not-dog classifier). In this scenario, a method for training a harmonic principal projection function f(v) may begin with obtaining 1201 training inputs, such as obtaining a first set of pictures depicting dogs, and a second set of pictures not depicting dogs. These inputs may then be projected 1202 onto a set of resonance anchors using the mapping function f(v), which may perform the projection based on parameters which are initially defined randomly, but which become more and more refined as the training proceeds. For example, if the semantic vector v was a vector in an embedding space having n dimensions, and the resonance anchors were the first m prime indices multiplied by a system wide resonance scaling constant, then the parameters of the mapping function f(v) may be a set of m coefficients for each value in the vector v, and the mapping function may project 1202 the vector v onto the frequency aligned vector fᵥ by multiplying each value in v by its m coefficients and then summing the results across each value in v to obtain phase offsets for the m anchors.

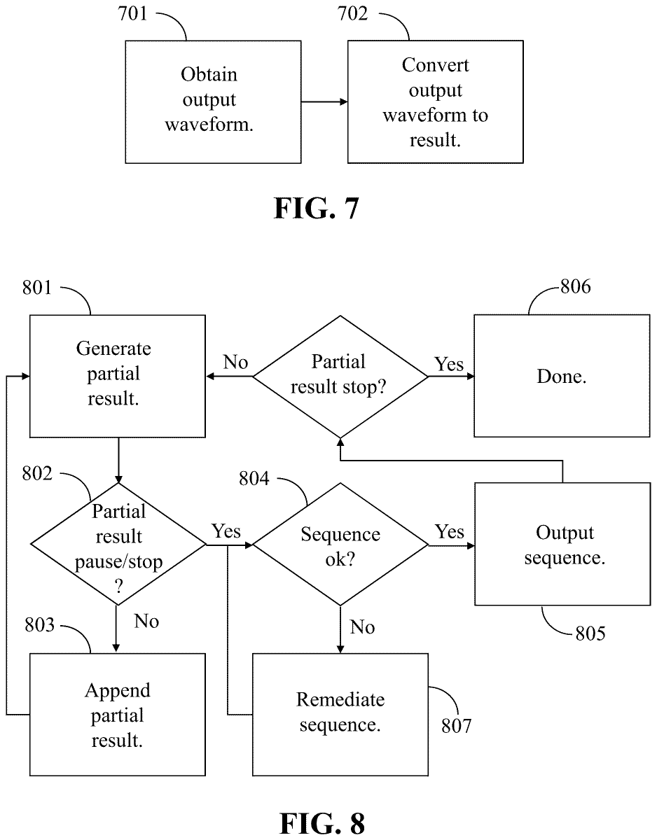

Once the projection 1202 had been completed, a loss may be calculated 1203 based on a difference between the output waveform for the projection and an archetypal output for the class corresponding to the input. For example, if the input was an image depicting a dog, and the output was converted to a result by treating L chirality output waveforms as dogs (see discussion of FIG. 7 for further discussion of how an output can be converted to a result), then the loss may be calculated 1203 by comparing (e.g., using cosine similarity of constituent frequencies, by subtracting phase offsets, etc.) the output obtained from the input to an output with an offset placing it in the middle of left chirality phase space (e.g., an offset of π/2). Similarly, if the input was an image not depicting a dog, and the output was converted into a result by treating R chirality waveforms as not-dogs, then the loss may be calculated 1203 by comparing (e.g., using cosine similarity of constituent frequencies, by subtracting phase offsets, etc.) the output obtained from the input to an output with an offset placing it in the middle of right chirality phase space (e.g., an offset of −π/2). The parameters of the mapping function f(v) may then be updated 1204 based on the loss (e.g., using standard back propagation), and this process may be repeated until all of the training data had been processed, until the parameters reached stable values, or until some other stopping condition was satisfied.

As another example of an approach which may be used in some cases, it is also possible that a lookup table defining relationships between tokens and frequencies may be used to obtain 202 the waveforms. A partial example of such a lookup table is provided below in table 1, indicating how values calculated using equation 1 may be pre-stored so they could subsequently be used in obtaining 202 waveforms without requiring the calculations to be performed at inference time.

TABLE 1
Partial lookup table for obtaining waveforms from tokens.

| Potential | Prime | Frequency (fₙ = |
|---|---|---|
| Token (tₙ) | Index (pₙ) | A * log(pₙ)) |
| “a” | 2 | 440 * ln(2) ≈ 305.0 Hz |
| “b” | 3 | 440 * ln(3) ≈ 483.4 Hz |
| “c” | 5 | 440 * ln(5) ≈ 708.1 Hz |

Other approaches to constructing lookup tables may also be used in some cases. For example, in some cases, a training dataset (e.g., the works of Shakespeare) can be processed, and the frequencies assigned to tokens during that processing (e.g., using harmonic principal projection, a calculation such as equation 1, etc.) may be used to populate a lookup table. It is also possible that frequencies determined using processing of multiple training datasets may be combined for this purpose. For example, rather than using the works of Shakespeare as a single training dataset, each individual play may be treated as a dataset, and, for each token appearing in any of Shakespeare's plays, the frequencies assigned to that token may be averaged across plays, and those averages may be used to populate a lookup table such as table 1. Further variations are also possible, and will be immediately apparent to those of skill in the art. Accordingly, the partial lookup table of table 1, like the exemplary calculations which preceded it, should be understood as being illustrative only, and should not be treated as limiting.

Continuing with the discussion of FIG. 2, once waveforms had been obtained 202 from the tokens, those individual waveforms may be combined 203 into a composite waveform. This may be done by adding 204 the waveforms together, and normalizing 205 the sum of the waveforms to fall within a fixed amplitude range (e.g., [−1, 1]). In this way, a composite waveform may be generated which can be treated as an input waveform for processing in a method such as shown in FIG. 1. However, other ways of generating such an input waveform are also possible. For instance, in some cases (e.g., when provided input in the form of an image), an input may be converted to a waveform through a mathematical transformation (e.g., Fourier transformation), rather than through tokenization and combination as described above. Accordingly, the discussion of FIG. 2 should be understood as being illustrative only, and should not be treated as implying limitations on how an input waveform may be obtained.

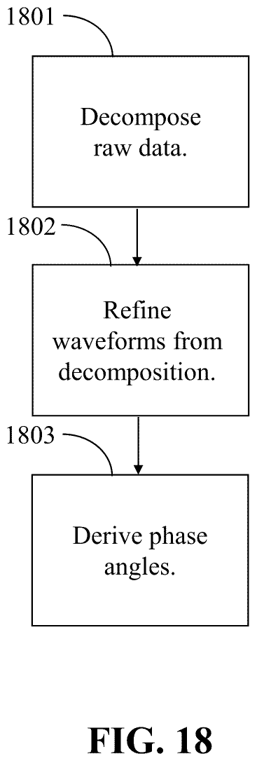

It should be understood that, in some cases inputs other than symbolic inputs (e.g., text strings such as those described above) may also be subjected to some level of processing to facilitate their being treated as input waveforms for purposes of a process such as shown in FIG. 1. For example, in cases of highly entropic input datasets, waveforms representing those sets may be simplified to facilitate subsequent analysis. To illustrate, consider FIG. 18, which illustrates a method by which such simplification may be performed. As shown in that figure, initially, raw data (e.g., spectral data from the Sloan digital sky survey) would be decomposed 1801 into component waveforms, such as through the application of a continuous wavelet transform. The component waveforms could then be refined 1802, such as by applying a fast Fourier transform to reduce the component waveforms to their dominant carrier frequency or frequencies. Finally, phase angles for those frequencies could be derived 1803 and applied using a Hilbert transform, thereby providing a set of normalized-reduced noise waveforms suitable for use in deriving resonance anchors.

Returning now to the discussion of FIG. 1, as shown in that figure, an input waveform may be used to derive 101 one or more prime resonance anchors. This may be done by populating a set of one or more data structures, each of which includes a prime frequency anchor, based on the input waveform. As an illustration of what this may entail, consider table 2, which provides an exemplary data structure for a prime resonance anchor such as may be used in some implementations.

TABLE 2
exemplary prime resonance anchor data structure.

| Attribute | Description |
|---|---|
| pₖ | Frequency anchor, which can take a prime |
| | number value (2, 3, 5, etc.) |
| C_{tag} | Chirality tag, indicating if this anchor |
| | has been assigned left or right handed spin. |
| Δφₖ | Phase offset, which can represent an amount |
| | to add to a constituent waveform to minimize |
| | phase deviation from the prime resonance |
| | anchor waveform. |
| hₖ | Harmonic compatibility coefficient, indicating |
| | resonance fit between a constituent waveform |
| | and its assigned anchor. |
| Cₖ | Coherence weight, which may be used in global |
| | scoring. |
| tₖ | Reference to originating token or constituent |
| | waveform. |

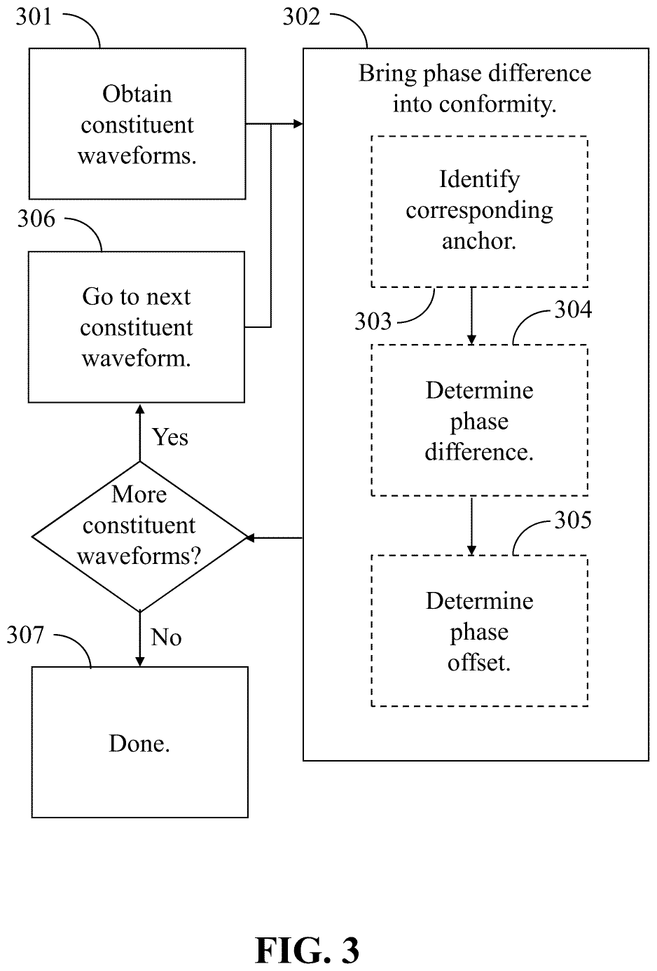

In such a data structure, some attributes may have values which are pre-assigned. For example, the attribute pₖ may simply have the value of the k^{th} prime number (e.g., if k is 1, then pₖ may be 2, if k is 2, then pₖ may be 3, etc.). Similarly, C_{tag} may be driven by the value of k, with C_{tag} having a value of ‘L’ if k is even or a value of ‘R’ if k is odd (or vice versa). Other attributes may have values which are determined based on an input waveform. For example, in some cases, the value of APk—i.e., the phase offset from the sinusoidal frequency anchor—may be determined according to a method such as illustrated in FIG. 3.

In the method of FIG. 3, initially, a set of constituent waveforms may be obtained 301 from the input waveform (e.g., through application of Fourier decomposition or other spectral analysis technique). Then, for each of the constituent waveforms, a phase difference for that constituent waveform relative to its corresponding resonance frequency anchor's prime waveform (e.g., a sine wave with a frequency calculated using the prime frequency anchor) can be brought 302 into conformity with a phase alignment threshold. This may start with identifying 303 a corresponding resonance frequency anchor (i.e., identifying the resonance frequency anchor whose frequency is closest to that of the constituent waveform in question, treating the k^{th} resonance frequency anchor as corresponding to the k^{th} constituent waveform, etc.). A phase difference between the waveform for that resonance frequency anchor and the corresponding constituent waveform may then be determined 304. This may be done by, for example, finding an average value of the distance between closest peaks in the two waveforms for a time equal to the lowest common multiple of the two waveforms' periods, considering only one (the smallest) distance value per peak in the waveform having the lowest frequency. A phase offset value is then determined 305 which, when used to shift the phase of the constituent waveform, reduces (and in some implementations, minimizes or eliminates) the difference between that waveform and the waveform for the resonant frequency anchor. This may be done by, for example, defining the opposite of the average distance between peaks as the offset, or by iteratively shifting the constituent waveform by an incremental amount until the difference was less than a predefined phase alignment threshold. The process could then go 306 to the next constituent waveform and repeat until such time as there were no further constituent waveforms for which a phase offset had not been determined, at which point the process could terminate 307.

Other attributes may also be determined based on the input waveform in some cases. For example, in some cases, a resonance anchor's harmonic compatibility coefficient (hₖ) may be determined based on the deviation in frequency and phase alignment between a constituent waveform and its resonance frequency anchor, such as by using equation 2, below.

$${h}_{k} = cos ( {θ}_{k} ) \times exp ( - \vert Δ {f}_{k} \vert / β ) \qquad Equation 2$$

In that equation, Δfₖ is the difference between the frequency of the constituent waveform and the frequency of the resonance anchor (e.g., pₖ in the example of table 2, after being subjected to a natural log transformation and multiplied by the system level resonance constant, as described in the context of equation 1), β is a harmonic tolerance constant (e.g., β=30 (Hz), representing a harmonic tolerance threshold which may be used in auditory phase separation modeling), and Ok is the phase difference between the constituent waveform and the anchor. It should be noted that, in some cases utilizing equation 2, θₓ may be equal to Δφₖ in the example of table 2, but may also differ from that attribute. For example, θₓ and Δφₖ may differ where Δφₖ is held constant while Ok varies. Similarly, in some cases a coherence weight (Cₖ) may be determined based on the harmonic compatibility coefficient (e.g., using a calculation such as Cₖ=hₖ*cos(Δφₖ)), or based on normalizing (e.g., projecting onto a range of −1 to 1, or 0 to 1) the phase difference between a constituent waveform when shifted by its phase offset and the waveform for the resonance frequency anchor corresponding to that constituent waveform, and then subtracting that normalized value from the limit of the normalization range. For instance, if the phase difference between a shifted constituent waveform and the waveform for its corresponding resonance frequency anchor had a value of 0.09 when normalized onto a range of 0 to 1, then the coherence weight (Cₖ) for that resonance frequency anchor may be calculated as 0.91 (i.e., 1-0.09).

Other approaches may also be used when populating a data structure such as that shown in table 2. For example, while the above description explained how an anchor's chirality may be determined based on the index of its prime frequency anchor, it is also possible that chirality may instead be determined based on the prime resonance anchor's corresponding constituent waveform. For instance, in some cases, the chirality tag may be set at ‘L’ if the smallest magnitude phase distance minimizing phase offset value was positive, or at ‘R’ if the smallest magnitude phase distance minimizing phase offset value was negative. Further variations are also possible and could be implemented without undue experimentation by those of ordinary skill in light of this disclosure. Accordingly, the above examples should be understood as being illustrative only, and should not be treated as limiting on how a prime resonance anchor could be derived from an input waveform.

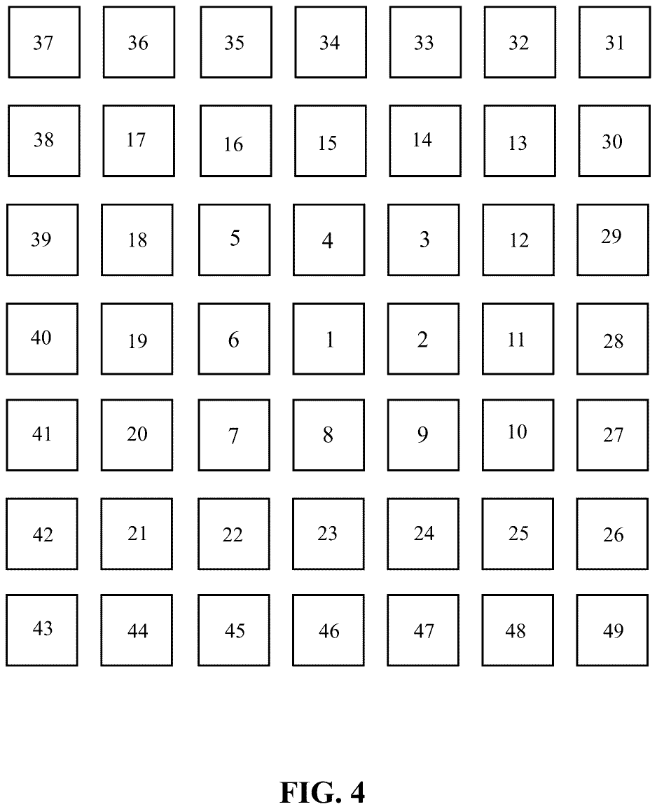

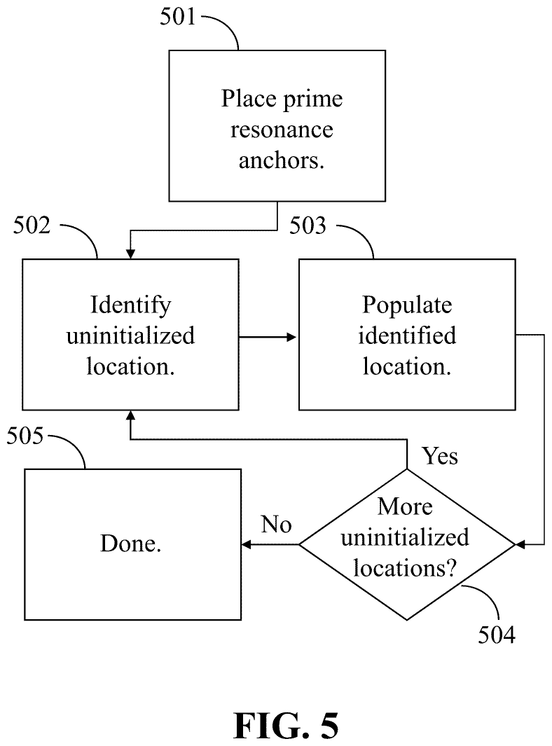

Continuing with the discussion of FIG. 1, once an input waveform's prime resonance anchor(s) have been derived 101, those anchors may be used to generate 102 one or more coherent peaks for a prime encoded resonance field. In this context, a prime encoded resonance field may be understood as a space in which each region is associated with a resonance anchor, some of which may be prime resonance anchors such could be derived 101 as described above. A 7×7 example of such a field made up of square regions is shown in FIG. 4 having integer labels organized in a configuration centered on one and increasing outward in a counter-clockwise spiral. A method which may be used for populating such a grid is illustrated in FIG. 5. In that method, initially, prime resonance anchors may be placed 501 at locations with integer values corresponding to their frequency anchors (e.g., attribute pₖ from table 2). After the prime resonance anchors had been placed, an uninitialized location (e.g., a region in the grid which was not occupied by an anchor) could be identified 502. This may be done, for example, by putting the unoccupied neighbors of each populated region (e.g., the neighbors of the prime resonance anchors) in a queue, and then treating the first element in that queue as the identified 502 uninitialized location. It is also possible that other approaches may be used in this identification 502. For example, in some cases, rather than simply removing regions from a queue in the order in which they were added, after the unoccupied neighbors had been added to the queue, they may be prioritized, such as by sorting them in descending order of the number of neighbors of each region in the queue which were already populated. Other approaches, such as identifying 502 uninitialized locations starting with the edges of a grid and working inward, are also possible, and may be utilized in some cases. Accordingly, the first in first out queue example described above should not be treated as implying limitations on how an uninitialized location may be identified 502.

However it is accomplished, once an uninitialized location has been identified 502, that location may be populated 503 with an anchor of its own. This may be done by assigning the attributes of the anchor based on those of its already populated neighbors in the grid. For example, in an implementation in which resonance anchors had the attributes from table 2, those attributes may be populated 503 for an anchor in an uninitialized location as follows:

TABLE 3
exemplary attribute assignments

| Attribute | Potential Assignment when Populating |
|---|---|
| pₖ | Assign prime value closest to the mean pₖ |
| | values of the already populated neighbors. |
| C_{tag} | Assign a value equal to the dominant (e.g., |
| | most prevalent) chirality of already populated |
| | neighbors, or a default (e.g., random) value |
| | if no such dominant chirality exists. |
| Δφₖ | Assign a value equal to the mean Δφₖ values |
| | of already populated neighbors, or a default |
| | value (e.g., 0, or a random value between −π |
| | and π weighted depending on the assigned value |
| | of C_{tag}). |
| hₖ | Assign a value equal to the cos(Δφₖ) |
| | multiplied by the exponential of the negative |
| | magnitude of the difference between pk and the |
| | mean pk values for the already populated neighbors, |
| | divided by a harmonic tolerance constant |
| | (exp(−\|pₖ−neighbor_mean(pₖ)\| / β) |
| Cₖ | Assign a value equal to the sum of Cₖ values of |
| | populated neighbors, weighted by distance (e.g., |
| | divided by √2 for diagonal neighbors) and |
| | divided by the number of populated neighbors. |

After a resonance anchor for the identified location had been populated 503, a check 504 may be made of whether there were more locations which did not yet have populated resonance anchors. If there were, then the process may identify 502 a next uninitialized location (e.g., adding the neighbors of the most recently populated location the back of a queue, and then identify the location at the head of the queue as the next location to be populated) and then proceed to populate 503 it. Alternatively, if there were no further uninitialized locations, then a process such as that shown in FIG. 5 may terminate as complete. Additionally, as part of this termination, certain information may be captured about the populated field, such as could be used for later analysis. For example, in some cases, once a field has been populated, phase alignment scores may be calculated for each of the anchors using calculations such as those set forth below as equations 3-5.

$${PAS}_{s} = Σ ( cos ( {θ}_{k -} {θ}_{n} ) / N ) \qquad Equation 3$$

$${PAS}_{m} = \vert Σ ( exp ( i * m * {θ}_{k} ) ) / N \vert \qquad Equation 4$$

$${PAS}_{h} = Σ ( {w}_{m} * {PAS}_{m} ) \qquad Equation 5$$

In those equations, PASₛ is a first order phase alignment score, Ok is the phase of the anchor k (e.g., Δφₖ from table 3) for which the phase alignment score (PAS) is being calculated. On is the average phase in the neighborhood of anchor k. N is the number of anchors in the neighborhood of anchor k. PASₘ is a phase alignment score for harmonic order m, which is a harmonic order from a set of harmonic orders M (e.g., if M is {1, 2, 3, 4} then m may be 1 or 2 or 3 or 4). The function exp (arg) is a function whose value is the constant e raised to the arg power. PASₕ is a multiharmonic phase alignment score. wₘ is a weight value for harmonic order m where the sum of weights for all harmonic orders in M is 1 and weights generally decrease as harmonic order increases (e.g., w₁ may be from 0.5-0.7, with w₂ being from 0.2-0.3, etc.). In cases where a PAS value is used for evaluation, some embodiments of the disclosed technology may calculate each of the potential PAS values noted above (i.e., PASₛ, PASₘ values for each m in M, and PASₕ), and then treat the evaluation as satisfied if any of the PAS values satisfy the evaluation, thereby avoiding the potential for phase alignments which occur only on particular harmonic orders to be missed.

It should be understood that, while the above discussion of FIG. 5 set forth how a prime resonance field such as shown in FIG. 4 may be populated, that discussion is intended to be illustrative only, and should not be treated as implying limitations on potential approaches to prime resonance field initialization. To illustrate potential variations which may be used in some cases, consider an implementation of the disclosed technology in which a prime resonance field, instead of being structured as a spiral of ascending integers as illustrated in FIG. 4, is structured as a coordinate plane with axes defined by resonance anchor attributes. In such a case, placing 501 prime resonance anchors may be performed by placing those anchors at coordinates defined by the values of those anchor's attributes which corresponded to the resonance fields axes. As another example of a potential type of variation, in some variations there may be a preliminary stage of defining the resonance field's parameters. An illustration of the type of processing which may be included in such a stage is provided in FIG. 13, discussed below.

As shown in FIG. 13, defining a resonance field's parameters may begin with determining 1301 a layout for the field. This may be driven by the entropy of the input to be processed using the resonance field, such as may be calculated using an equation like equation 6.

$$E = - Σ ( {p}_{i} * {log}_{2} ( {p}_{i} + ε ) \qquad Equation 6$$

In that equation, E is the entropy of the input, ε is a constant value (e.g., 10⁻⁹) used to avoid undefined log values, and pᵢ is the probability of the i^{th} potential value for the input (e.g., if the input was made up of tokens, the pᵢ could be the frequency of the i^{th} token in the input; if the input was a waveform, then pᵢ may be the probability of the input falling into the i^{th} bucket after being quantized based on amplitude or frequency). That entropy value may then be used to select whether to use a structured position grid (e.g., a spiral layout such as shown in FIG. 4) or a spatial grid with axes defined by resonance anchor attributes. For example, for relatively lower entropy inputs (e.g., E values less than or equal to 2.5) a structured position grid may be used, while for relatively higher entropy inputs (e.g., E values of greater than 2.5) a spatial grid with axes defined by resonance anchor attribute may be used. Similarly, an entropy value may also (or alternatively) be used to determine the resonance field's size. This may be done using a piecewise function, such as one which applies the exemplary rules set forth below in table 4.

TABLE 4
Exemplary resonance field size definition rules

| Entropy | Resonance field size |
|---|---|
| E <= 1.5 | 49 (i.e., 7²) regions |
| 1.5 < E <= 2.5 | 144 (i.e., 12²) regions |
| 2.5 < E <= 3.5 | 289 (i.e., 17²) regions |
| 3.5 < E <= 4.5 | 484 (i.e., 22²) regions |
| 4.5 < E <= 5.5 | 729 (i.e., 27²) regions |
| 5.5 < E | 1024 (i.e., 32²) regions |

Continuous scaling formula approaches to size determination are also possible, such as applying a formula such as S=└a·2\hat{ }(b·E)┘, where a and b are constants which may be given tunable or default (e.g., a=6, b=0.75) values, and S is the size, which may be rounded to the nearest square number to be applied.

Other approaches to determining 1301 a resonance field's layout, including approaches which are not driven by entropy calculations such as those described for equation 6, may also be used in some cases. For instance, in some embodiments, the layout may be driven by the type of input to be processed, rather than a specific calculation of its entropy. In this type of approach, there may be heuristic rule that short form symbolic prompts would be processed using a resonance field with 196 anchors (e.g., a 14×14 grid), while an input generated by fusion of multi-modal data would be processed using a resonance field with 625 anchors (e.g., a 25×25 grid). It is also possible that the layout determination 1301 may be performed using a combination of heuristic and calculation based approaches (e.g., grid size could be determined heuristically, while grid type could be determined using the entropy calculation of equation 3). As another possibility, in some cases, factors other than entropy or the type of prompt being provided may be used in determining 1301 the layout of the resonance field. For example, it is also possible that the length of the input (e.g., number of tokens) or the precision desired for the output (e.g., resolution of an automatically generated image) may be considered. Accordingly, the examples described above should be understood as being illustrative only, and should not be treated as implying limitations on how a resonance field's layout may be determined in embodiments of the disclosed technology.

Continuing with the discussion of FIG. 13, once the layout had been determined 1301, a determination 1302 may be made as to whether the layout determination indicated an attribute-based layout—e.g., a spatial field with axes defined by resonance anchor parameters. If it did not, then the parameter definition stage may be considered as complete 1303. Alternatively, if the layout determination 1301 did indicate an attribute based layout, then the process of FIG. 13 may continue with determining 1303 the attributes. This may be done, for example, by identifying the attributes whose values had the greatest deviation among the resonance anchors for the inputs to be processed, though other approaches, such as identifying the attributes whose values had the greatest range among the inputs to be processed, are also possible, and may be used in some implementations which perform a method such as that of FIG. 13.

Continuing with the discussion of coherent peak generation 102 from the method of FIG. 1, after a prime resonance field had been populated, it may be brought into a coherent state using a method such as that shown in FIG. 6. As shown in that figure, coherent peak generation may begin with bringing 601 the resonance field into a coherent state. This may include, for each resonance anchor in the prime encoded resonance field, calculating 602 a coherence delta (e.g., an average difference between the coherence value of that anchor (e.g., attribute Cₖ in table 2) and the coherence values of the anchors in the neighboring regions of the prime encoded resonance field) for that anchor. These coherence deltas can then be used to update 603 the resonance field. For example, for each of the anchors in a prime resonance field, an updated phase offset value for that region may be calculated by calculating a correction value for that anchor's phase offset using a formula such as equation 4, below.

$$Δ {φ}_{i} = α * Σ ( Δ {C}_{j} * {w}_{j} ) \qquad Equation 7$$

In that equation, a is a correction rate constant. A typical value for the correction rate constant a is 0.015, which balances convergence speed with resonance stability in medium-size fields (e.g., 121-400 anchors) and in some cases may be tuned adaptively based on coherence slope or system latency constraints. In equation 7, Api is the correction value for anchor i in the resonance field, ΔCⱼ is the coherence delta for anchor j where that anchor is a neighboring anchor for anchor i in the resonance field, and wⱼ is a symmetry based spatial weight for anchor j. Symmetry-based spatial weight (wⱼ) may be determined by evaluating geometric proximity and chirality alignment between anchor j and anchor i within the resonance field grid. This weight can be computed as a function of spatial adjacency (e.g., Manhattan or radial distance), chirality coherence (e.g., same or alternating spin), and harmonic phase gradient similarity. For example, anchors directly adjacent to i with matching chirality may receive higher weights (e.g., wⱼ=1.0), while diagonal or phase-inverted neighbors may receive lower weights (e.g., wⱼ=0.25 or less). In some implementations, these weights are normalized to ensure local symmetry compliance during feedback updates.

It is also possible that phase offsets may be updated based on temporal relationships rather than spatial relationships. For example, in some cases calculations such as those set forth below as equation 8 may be used in updating phase offsets for anchors in a resonance field.

$${θ}_{k} ( t + 1 ) = {θ}_{k} ( t ) + 2 π {f}_{k} * Δ t \qquad Equation 8$$

In that equation, θₖ(t+1) is the value which will be assigned to the phase offset of resonance anchor k when it is updated. θₖ(t) is the pre-offset (e.g., current) phase offset of resonance anchor k. fₖ is the natural frequency of resonance anchor k, which may be calculated using the prime frequency anchor of resonance anchor k (e.g., attribute pₖ from table 2) with equation 1. At is a time scaling constant, which is set at 1 if the resonance anchors do not have time attributes, and which is set according to the resonance anchor sampling frequency where time attributes are present (e.g., where resonance anchors corresponding to measurements taken at a 4096 Hz sampling rate, At could be set at a corresponding value of 1/4096). Combinations of updates based on spatial and temporal relationships may also be included in some cases. For example, in some implementations, time based updates such as using equation 8 may initially be used, while spatially based updates such as using equation 7 may be used if remediation is needed (e.g., a resonance field achieves coherence but later transitions into a decoherent or less coherent state).

In some implementations, updating 603 a resonance field may also include updating other attributes of anchors in the resonance field. For example, resonance field updating 603 may include updating the chiralities of one or more of the field's anchors. In some cases, these chirality updates may be performed based on the neighborhoods of each anchor. For instance, a calculation may be made of a gradient of the local phase deviation (e.g., by computing the first derivative of the phase offset across neighboring anchors) and assigning chirality tags based on the sign of the gradient (e.g., a negative gradient across an anchor's neighbors may result in that anchor being assigned a C_{tag} value of R, while a positive gradient may result in the anchor being assigned a C_{tag} value of L). Another approach which may be used to update an anchor's chirality based on its neighbors is triggering chirality updates when an anchor is part of a locally coherent harmonic scaffold. An example of where this would be the case is when an anchor is part of a triplet with frequencies approximating a 1f-2f-3f pattern within an applicable tolerance window. As an illustration, the anchors with pₖ=3, pₖ=19, and pₖ=113 yield frequencies that roughly approximate ln(3), 2·ln(3), and 3·ln(3) which, if those frequencies fall within a resonance error margin (e.g., ≤2.5%), may result in those anchors being treated as a harmonically complete triplet. In a case where such a scaffold is detected, the chirality of the anchors in the scaffold can then be updated based on the group as a whole. For example, the offsets of each anchor in the group can be added, and the chirality of the group as a whole can be set based on those combined offsets (e.g., if the offset is between 0 and π, the chirality could be set at L, while if it was between π and 2π, the chirality could be set at R).

Time based updates to chirality may also be supported in some cases. For example, in some implementations, if an anchor's chirality remains inconsistent with its neighbors' chiralities over multiple updates, this may cause the anchor's chirality to flip, or to be more likely to flip. This may be done by, for each anchor, maintaining a buffer of values indicating a differential between its chirality and the chiralities of its neighbors, and decreasing a threshold required for an anchor's chirality to flip the longer that anchor's buffer reflects the existence of a persistent chirality differential.

It should be understood that, while the above discussion of chirality updates focused on shifts from L to R or R to L chirality, it is also possible that shifts to or from other values may take place in some cases. To illustrate, consider a case where there is a persistent mismatch between an anchor's chirality and its phase offset (e.g., the anchor has a chirality of R, and a phase offset between π/2 and π which lasts for three or more update cycles). In such a case, the mismatch may be seen as causing the chirality to be misleading, in which case some implementations may change the chirality value to value such as N (for neutral chirality) or B (for bi-chiral). Subsequently, these types of non-binary chiralities may then be switched back to either an L or R chirality (e.g., based on harmonic scaffolds or phase offset gradients, as described above).

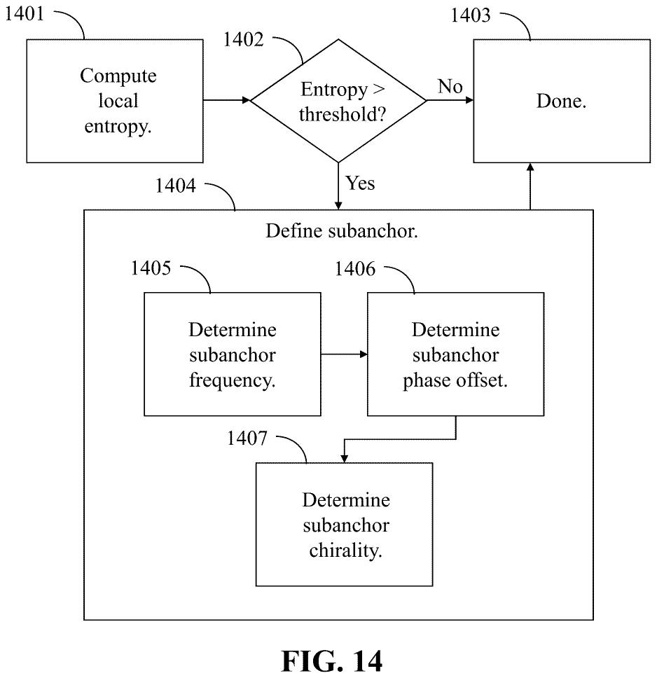

It should also be understood that, while the above description explained how attributes such as chirality and phase offset could be modified in a resonance field update 603, such an update 603 may also include changes other than to anchor attributes as described. To illustrate, consider an implementation in which individual anchors may be assigned subanchors, such as to model residual structure which may contribute to issues such as unstable phase offsets or low harmonic compatibility. An example of a method which may be used to determine if an anchor should have a subanchor added, and to define such a subanchor when it is determined that it should be present, is provided in FIG. 14. As indicated in that figure, determining whether an anchor should have a subanchor assigned may begin with computing 1401 a local entropy value for the anchor. This may be done, for example, using equation 9, in which Eₖ is the entropy of anchor k, and Δφₖ and hₖ are attributes of the anchor having the meanings described above in the context of table 2.

$${E}_{k} = \vert Δ {φ}_{k} \vert - {h}_{k} \qquad Equation 9$$

In the method of FIG. 14, once the anchor's local entropy has been computed 1401, that entropy may be compared 1402 with a threshold value (e.g., 0.4, representing a coherence instability threshold derived from phase alignment differential volatility across successive updates). If the entropy exceeded the threshold, then the method may complete 1403 without a subanchor being assigned. Alternatively, a new subanchor may be defined 1404, starting with determining 1405 the new subanchor's frequency. This determination 1405 may be made by identifying the lowest prime number which (1) was not already used as a frequency anchor for any resonance anchor in the resonance field and (2) had a greatest common divisor of 1 relative to the frequency anchor of resonance anchor k, plus or minus some range value (e.g., 1). With the subanchor's frequency determined 1405, that frequency may be used to determine 1406 the subanchor's phase offset, such as by identifying the phase offset which minimizes destructive interference between the resonance anchor k and its subanchor (e.g., minimizes the summation of |Δφₛ−Δφₖ| over the range of 0 to 2ₓ, where Δφₛ is the phase offset for the subanchor being defined, and Δφₖ is the phase offset for resonance anchor k).

As shown in FIG. 14, defining 1404 a subanchor may also include determining 1407 the subanchor's chirality. This type of determination may be based on considering a phase-alignment score that decreases over time as indicating field instability, a stable or increasing phase alignment score as indicating convergence toward coherent alignment, and an excessively rapid increase followed by oscillation as signaling transient instability. When making a subanchor chirality determination 1407, changes in a phase alignment score for the main anchor (i.e., the anchor for which a subanchor would be defined), such as could be calculated using equations 3-5, may be considered. In such a case once a phase alignment score is used to define a subanchor, if the score for anchor k decreased over time, then this may be seen as indicating field instability, and the subanchor may be given a chirality value which inverts that of anchor k (e.g., if anchor k has chirality of L, then the subanchor would have chirality of R, and vice versa). Alternatively, if the phase alignment score for anchor k increased over time, then this may be seen as indicating the field is stabilizing, and the subanchor may be the same chirality as the anchor for which it was being defined. In either case, once the subanchor had had its frequency, phase offset and chirality determined, the definition 1404 of that subanchor may be seen as complete, and the process of FIG. 14 may end 1403. Thereafter, the subanchor may be considered in combination with the anchor to which it was assigned. For example, when updating an anchor's phase with a phase correction calculated using equation 7, phase corrections may be calculated for both an anchor and its subanchor, and then added together to determine an aggregated phase correction which would be applied to the main anchor. This may be done using a formula such as equation 10, below.

$$Δ {φ}_{i} = α * Σ ( Δ {C}_{j} * {w}_{j} ) + γ * Σ ( Δ {C}_{s - j} * {w}_{s - j} ) \qquad Equation 10$$

In that equation, Δφᵢ, α, ΔCⱼ and wⱼ have the same meanings as in equation 7, while γ is a subanchor influence factor (typically less than α), ΔCₛ₋ⱼ is a coherence delta for anchor j relative to subanchor s, and wₛ₋ⱼ is a weight value for subanchor s which may be determined relative to subanchor j the same way that the value of wⱼ could be determined for the main anchor.

While the discussion of FIG. 14 explained how an anchor may have a subanchor added and defined as part of a resonance field update 603, it should be understood that that explanation is intended to be illustrative only, and that alternative approaches may be used in some cases. For example, in some implementations in which a subanchor may be added, the determination of whether to add a subanchor may be made based on whether anchor k (i.e., the anchor to which a subanchor may be added) has a value for Δφₖ greater than 0.2 and a value for hₖ less than 0.4 (in which case a subanchor would be added), rather than making that determination using the entropy calculation of equation 9. Similarly, in some cases a subanchor's frequency anchor (i.e., attribute pₖ from table 2) may be defined as the prime value closest to half of the frequency anchor for the resonance anchor to which the subanchor would be added (i.e., anchor k), and the subanchor's phase may be determined by simply mirroring the phase of the main anchor.

As another example, in some cases, an implementation which may add a subanchor may also support functionality for removing subanchors. In some embodiments, removal of a poorly aligned subanchor indirectly increases the main anchor's PAS by reducing destructive interference. For example, in some cases, as part of resonance field updating 603, a calculation may be made, for each anchor which has a subanchor, whether a PAS (e.g., multiharmonic PASₕ, calculated as set forth in equation 5) for that anchor and/or for the field would increase if the subanchor were not included in its calculations and, if the PAS was found to increase by more than a threshold amount, the subanchor may be removed. Similarly, if a subanchor was found to have a phase correction value (e.g., as calculated using equation 10) which was converging to zero, along with a harmonic compatibility coefficient (e.g., as could be calculated using equation 2, or as reflected in PASₕ or PASₘ values calculated using equations 4 or 5) which was increasing, then that subanchor may be removed as a subanchor and inserted into the resonance field as a full resonance anchor (e.g., at a location in the field of FIG. 4 with an integer label corresponding to the frequency anchor, assuming that that location was available). Other variations on the definition and handling of subanchors are also possible and could be implemented without undue experimentation based on this disclosure. Accordingly, the above description of variations, like the discussion of subanchors set forth in the context of FIG. 14, should not be treated as implying limitations on the scope of protection provided by this document or any related document.

Another example of an approach which may be taken in some implementations to update 603 a resonance field is to organize resonance anchors into a set of predefined classes, and then modify those anchors' attributes based on the classes assigned to them. To illustrate, consider an implementation where resonance anchors are treated as having one of the five classes set forth below in table 5.

TABLE 5
Exemplary anchor classes

| Anchor class | Anchor description |
|---|---|
| Prime resonance | Anchors which are derived from input waveforms. |
| anchor | |
| Silent anchor | Anchors which do not have a subanchor, and which |
| | have phase offsets of zero or near zero (e.g., |
| | within a threshold distance of zero). |
| Composite anchor | Anchors which have subanchors and which are not |
| | located at a boundary (e.g., an edge) of the |
| | resonance field. |
| Mirror/boundary | Anchors which have a chirality tag other than L |
| anchor | or R, and which are located at the boundary of |
| | a resonance field. |
| Null anchor | Anchors which have subanchors and which have phase |
| | offsets of at or near zero. |

In such a case, updating a resonance field may include, for each anchor in the field, assigning that anchor a class based on a gradient (e.g., with respect to a dominant phase propagation vector across the resonance field) of coherence values among neighboring anchors (ΔC_{local}) using logic which would classify the anchor as a silent anchor if the value of ΔC_{local} was less than 0.05, would classify it as a boundary/mirror anchor if it was on a boundary and the value of ΔC_{local} was greater than 0.3, would classify the anchor as a composite anchor if it was not on a boundary and the value of ΔC_{local} was greater than 0.3, or would classify the anchor as a null anchor if it didn't meet any of the preceding conditions and did meet the condition(s) applied in that implementation for adding a subanchor. Once the class had been assigned, the anchor's attributes (potentially including whether it had a subanchor) could be updated based on the class assignment. For example, if an anchor was classified as a silent anchor or a null anchor, then its phase offset could be updated by being set to zero, rather than to a value determined based on a correction value such as could be calculated using equation 7. Similarly, if an anchor was classified as a composite anchor, then updating it may include assigning it a subanchor (e.g., using a method such as shown in FIG. 14) regardless of whether the anchor would otherwise satisfy the conditions for subanchor assignment. If an anchor was classified as a mirror/boundary anchor, then its chirality could be updated reflect (though not necessarily match) the chirality of the nearest non-mirror/boundary anchor. For example, if the chirality of the nearest non-mirror/boundary anchor was L, then a mirror/boundary anchor may be given a chirality of ZL, which could be treated as a neutral chirality for purposes of updating the chirality of the mirror/boundary anchor's neighbors, but could be treated as a L chirality for purposes of determining an output following the resonance field being brought into coherence (e.g., as discussed in the context of FIG. 6).

It is also possible that, in some implementations, a resonance field update may involve modifying several anchors as a unit. To illustrate how this may take place, consider an implementation in which anchors from prior coherent states are stored in a phase memory buffer (e.g., as described in the context of FIG. 8). In such an implementation, if a group of one or more resonance anchors in a resonance field whose frequency anchors matched (e.g., exactly or within a tolerance level, depending on the implementation in question) the frequency anchors of a group of anchors in the phase memory buffer (and potentially one or more other conditions were satisfied, such as the group of anchors in the resonance field exhibiting persistently low coherence), then a determination may be made as to whether the overall coherence of the resonance field (e.g., a field PAS value calculated using equation 12, below) would increase if anchors in the resonance field were replaced with the corresponding anchors from the phase memory buffer. If so, then the replacement may be made, thereby allowing a prior coherent state to be reintroduced into the resonance field if and as appropriate (e.g., in the event of degradation in the resonance field's coherence).

In addition to (or as an alternative to) modifying resonance anchors, in some cases updating 603 a resonance field may modify aspects of the resonance field itself, such as by modifying its dimensions. For example, in the event that a resonance field has dimensions corresponding to resonance anchor attributes (e.g., frequency and harmonic compatibility), and a new resonance anchor is to be added with an attribute which exceeds the bounds on one of the dimensions (e.g., a resonance anchor with a frequency greater than the maximum frequency of the resonance field is to be added, such as because a new input has been provided, or because a subanchor with the higher frequency is to be used to create a new resonance anchor) the limits of the applicable dimension may be increased to accommodate the new resonance anchor. The new resonance anchor may then be added at the appropriate location in the newly expanded resonance field, while the remaining locations in the expanded field may be populated using techniques such as described in the context of FIG. 5 for initially populating the resonance field. It is also possible that a new dimension may be added, rather than (or in addition to) expanding an existing dimension for a resonance field. For instance, in some implementations, if there is a collision between resonance anchors (e.g., it is determined that a subanchor should be used to create a new resonance anchor, but the location in the resonance field where the new resonance anchor would be placed is already occupied by a prime resonance anchor previously created based on an input waveform), then a new dimension may be added to the resonance field (e.g., if there is a collision in a resonance field with dimensions of frequency and harmonic compatibility, a third dimension of coherence weight may be added) to accommodate each of the colliding anchors. As another example, in some cases the addition of a new dimension to a resonance field may be triggered based on density of a particular resonance field region exceeding some threshold amount. For instance, in some cases a local symmetry density may be calculated using equation 11, below, and if that symmetry density exceeds a tunable threshold (e.g., 0.65 when local mirror symmetry exceeds 65% in a bounded anchor region of radius 3), a new dimension may be added.

$${S}_{d} = Σ ( {S}_{k} ) / N \qquad Equation 11$$

In equation 11, S_{d} is the local symmetry density, N is the number of anchors in the neighborhood for which the local symmetry density is being calculated, and Sₖ is an individual symmetry score (e.g., parameter wⱼ in equation 7) for each anchor K in the neighborhood for which the local symmetry density is being calculated.

Continuing with the discussion of FIG. 6, in the method depicted in that figure, after the resonance field has been updated 603, a check 604 may be performed to determine if the field has been brought into a coherent state. This may include comparing one or more scores with thresholds used to indicate the coherence of the field. For instance, in some cases the check 604 may include determining whether the maximum coherence delta (e.g., which may be calculated as described above in the context of equation 7) for all prime resonance anchors across the field was below a coherence threshold value (e.g., 0.9) and, if it was not, continuing to iterate through the process of bringing 601 the resonance field into a coherent state. It is also possible that the check 604 may include calculating new values, such as phase alignment or global emission scores for the resonance field, which may be calculated, respectively, using equations 12 and 13, below.

$${PAS}_{s} = Σ cos ( {θ}_{k} - {θ}^{-} ) / N \qquad Equation 12$$

$$GES = Σ ( cos ( {θ}_{k} ) * {h}_{k} * {C}_{k} ) / N \qquad Equation 13$$

In those equations, PASₛ is a first order phase alignment score for a resonance field; GES is a global emission score for a resonance field; Ok is the phase offset (attribute Δφₖ from table 2) of the k^{th} anchor in the resonance field; hₖ is the harmonic compatibility coefficient for the k^{th} anchor in the resonance field; Cₖ is the coherence weight for the k^{th} anchor in the resonance field; N is the number of active anchors in the resonance field (this is the number of anchors which are included in the summation, and may be all anchors in the field, but also may be all anchors except for silent anchors and null anchors, in implementations where the anchor types of table 5 are used); and θ is the average phase offset of the active anchors in the resonance field.

Other types of calculations may also be included in a coherence check 604 such as that illustrated in FIG. 6. For example, in some cases, rather than using a PASₛ value calculated using equation 12, it is possible that a PAS for the resonance field could be calculated using the PASₘ or PASₕ calculations of equations 4 and 5, but with PASₘ calculated as the sum of each anchor in the field relative to the field itself, rather than only as the value of a particular anchor. In such a case, if any of the PAS values (i.e., any of the field-wide PASₛ, PASₘ or PASₕ values) indicated coherence, then the field could be treated as having reached a coherent state. Similarly, it is also possible that some implementations may check coherence based on changes over time. For example, in some cases values for monitoring PAS drift may be calculated using equations 14 and 15, below.

$${y}_{k} ( t ) = cos ( {θ}_{k} ( t ) - θ ( t ) ) \qquad Equation 14$$

$$Δ {PAS}_{ζ} ( t ) = ( 1 / ( W * N ) ) * {\sum }_{w = 1}^{W} {\sum }_{k = 1}^{N} \vert {y}_{k} ( t - wΔt ) - {y}_{k} ( t - ( w + 1 ) Δ t ) \vert \qquad Equation 15$$

In those equations, θₖ(t) is the phase offset of anchor k at time t. θ(t) is the average phase over the resonance field at time t. W is a window of time steps over which the APAS& value would be calculated. N is the number of anchors in the resonance field. At is the size of a time step. Where calculations such as those from equations 14 and 15 are performed, if those calculations indicate excessive drift (e.g., the value of ΔPAS_{ξ}(t) is greater than a threshold), then the resonance field may be treated as not being coherent.

In implementations in which the coherence check 604 of FIG. 6 is performed using a PAS (e.g., PASₛ, PASₘ and/or PASₕ) for the resonance field, the check 604 may include comparing the PAS value with a threshold such as 0.91 (or such other value as may be defined based on factors such as criticality of the output or system entropy, both of which would tend to indicate higher thresholds, or processing latency tolerance or increased resonance field size, both of which would tend to indicate lower thresholds), and treating the field as coherent if the PAS value was greater than or equal to the threshold. Similarly, in implementations where the coherence check 604 is performed using a GES for the resonance field, the GES value may be compared with a threshold such as 0.85 (or such other value as may be defined based on factors such as stricter external signal alignment constraints or task domain sensitivity, which would tend to indicate a higher threshold, or temporal urgency, which would tend to indicate a lower threshold), and the field may be treated as coherent if the GES value was greater than or equal to its threshold. Rates of change may also be used to determine coherence values in some cases. For example, in some cases a resonance field may only be treated as coherent if the rate of change between update in one of the above calculated values (e.g., PAS) had fallen below some threshold (e.g., 0.001).

Variations on how coherence could be evaluated 604, such as combinations of the above described approaches, are also possible, and may be implemented based on this disclosure. For example, in some cases a coherence check 604 may include determining if the resonance field appears to be internally consistent (e.g., as reflected by it having a PAS value greater than the PAS threshold used in that implementation), and determining if it appeared likely to be consistent with external requirements (e.g., as may be reflected in having a GES value greater than the GES threshold used in that implementation), and only treating the field as coherent if both of those determinations were positive (e.g., both PAS and GES values met or exceeded their respective thresholds). Rates of change may also be included in such a combined approach. For example, in some cases if the rate of change in a resonance field's PAS value fell below a first threshold amount (e.g., 0.001) without the magnitude of the resonance field's PAS value rising above a second threshold (e.g., 0.91), then the resonance field may be treated as decoherent, with a GES value only be evaluated if the rate of change falls below the first threshold and the PAS value magnitude rising above the second threshold. Other variations on how a resonance field may be checked for coherence (e.g., tracking the number of update iterations and treating the field as decoherent if a maximum number of iterations is reached without the field attaining a coherent state) are also possible, and could be implemented without undue experimentation by those of skill in the art in light of this disclosure. Accordingly, the above examples of how a resonance field coherence check may be performed should be understood as being illustrative only, and should not be treated as limiting.

In the method of FIG. 6, once a field had been brought 601 into a coherent state, the process could continue with determining 605 one or more peak values for the (now coherent) prime encoded resonance field. In some cases, this may be as straightforward as identifying a center point in the data which was used to create the (now coherent) resonance field. For instance, if the dataset is a series of measurements which are continuous across one or more dimensions (e.g., seismic measurements over time and/or space), then the peak may be determined by identifying a central point within that dataset across its dimensions (e.g., the point which is the midpoint in time and space in a dataset of seismic readings). However, in other cases, such as where the resonance field was created based on anchors derived from discrete symbols (e.g., n-grams in a natural language string), some additional processing may be involved. For instance, as illustrated in FIG. 6, in some cases, determining 605 one or more peak values may be conceived as including two stages, a filtration stage and an identification stage. Starting with filtration, in some cases, peak value determination 605 may begin with filtering 606 which anchors in the resonance field could be considered to be peaks, such as by applying a chirality-phase filter which would only allow resonance anchors to be considered as peaks if their chiralities were consistent with their phase offsets (e.g., L chirality anchors having phase offset values of <=π/4, R chirality anchors having phase offset values of >=3π/4). Other types of filters may also be applied. To illustrate, consider a case where the disclosed technology was used to generate an output via processing which could take place over multiple time steps (e.g., generating a sentiment label for an input string of text where each word is processed in the order it appears in the string and the label is updated as processing completes for each word; the output is a multi-word response to a prompt, where words in response are generated sequentially and then emitted as a whole once the response satisfies whatever internal conditions are applied in that implementation). In such a case, a phase alignment score (e.g., as may be calculated as described in the context of FIG. 14) may be tracked for each anchor across time steps and differences in that score across time steps may be compared with a filtration value and if any of the differences in the anchor's phase alignment score across time steps exceeded the filtration value (e.g., a set threshold such as a value between 0.02 and 0.15, or an adaptive value based on the standard deviation of PAS values across a time step window, such as five time steps), then that anchor may be filtered out of consideration as a potential peak for the coherent resonance field.

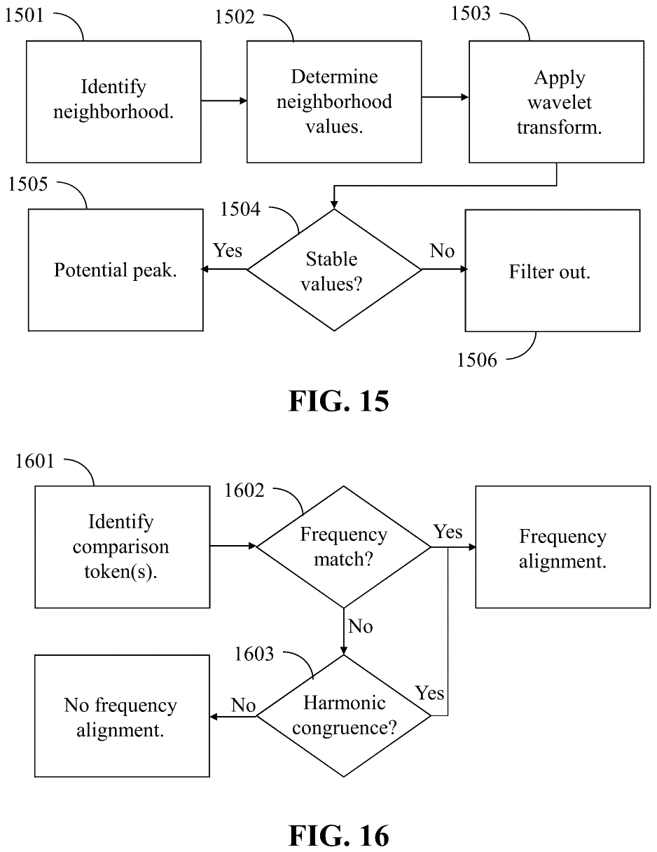

Another example of how peak filtration 606 might be performed is through the use of wavelet transforms. A method by which wavelet transforms may be used in peak filtration is provided in FIG. 15. As shown in FIG. 15, such a method may begin by identifying 1501 a neighborhood of the anchor to which the wavelet transform filter is being applied, such as a 3×3 or 5×5 square centered on that anchor in a resonance field made up of square regions such as illustrated in FIG. 4. Values may then be determined 1502 for each of the anchors in the neighborhood. These values may be existing values, such as coherence weights (e.g., attribute Cₖ in table 2), or anchor-level PAS values (e.g., which may be calculated as described previously in the context of equations 3-5). However, other types of values may also be used. For instance, in some cases, each anchor may be given a value equal to Cₖ×hₖ×cos (Δφₖ) (all parameters having the same meanings set forth in table 2) so as to incorporate harmonic fit and phase offset in the values for the neighborhood. A wavelet transform may then be applied 1503 to the neighborhood. This may be done by applying a discrete or continuous wavelet transform to decompose the neighborhood into a plurality of instances of a mother function (e.g., Mexican hat, Morlet, or complex Gaussian), each of which would be associated with coefficients indicating scale (frequency) and location. A check 1504 may then be performed of whether local maximum values for the neighborhood (e.g., as reflected by the wavelets' location coefficients) were persistent across multiple scales (e.g., as reflected by the locations having a coefficient of variation below a threshold value regardless of the values of their scale coefficients). If the local maximum values were persistent, then the anchor being evaluated (e.g., the anchor at the center of the neighborhood) may be treated 1505 as a potential peak. Otherwise, it may be filtered out 1506 and excluded from further consideration (at least until there was some change in state which may require new peaks to be determined 605).

Peak value determination 605 could also include identifying 607 peaks in the resonance field. As with filtering 606, this identification 607 could be performed in a variety of manners. For example, in some cases, values such as those mentioned above in the context of determining 1502 neighborhood values in the method of FIG. 15 may be compared across anchors, and the anchor(s) with the highest value (either globally or in their respective neighborhoods) could be treated as the resonance field's peak(s). It is also possible that, in some implementations, a threshold may be applied, with all resonance anchors with values above the threshold being treated as peaks for the coherent state resonance field. Similarly, in some cases chirality tags may be used to expand the identified peaks, such as by identifying anchors independently for the potential chirality tag values (e.g., identifying the highest value anchor with a ‘L’ chirality tag and a highest value anchor with an ‘R’ chirality tag, rather than simply identifying the highest value anchor as the resonance field's peak). Other approaches to peak value determination 607, such as treating all anchors which were not excluded by filtration 606 as peaks are also possible, and could be implemented in some variations based on this disclosure.

It should be understood that, while the above description provided both examples of peak value determination 605, as well as variations on how those examples may be implemented, both those examples and variations are intended to be illustrative, and that potential implementations of the disclosed technology are not limited to the above described approaches to peak value determination. To illustrate a potential further variation, consider the application of a wavelet transform to peak filtration 606. In some cases, using a wavelet transform for peak filtration may include steps which are different from (or in addition to) those describe above. For instance, in some cases, when applying 1503 a wavelet transform, prior to decomposing the neighborhood values into instances of the mother wavelet, one or more preprocessing steps may be applied to the neighborhood, such as dimensionality reduction (e.g., reducing a neighborhood to one dimension by flattening it along radial slices or diagonals) and/or applying a preliminary low pass filter. As another example, while the above description began with filtration 606 and followed it with peak identification 607, in some implementations the opposite order of steps may be used—i.e., peaks may be identified 607 and then one or more filters may be applied to those peaks after identification. Indeed, it is possible that some implementations may not have a distinction between filtering and identification at all, and may simply treat determining peak values as the application of a set of conditions to anchors (e.g., does this anchor have the highest coherence value in the field, are this anchor's chirality and phase aligned). Other variations (e.g., only requiring an anchor to satisfy a subset of conditions to be considered a peak, lowering a threshold to be considered a peak based on values used in other evaluations (e.g., close alignment between chirality and phase)) are also possible, and could be implemented by those of skill in the art without undue experimentation in light of this disclosure. Accordingly, the above variations, like the variations and examples which preceded them, should be understood as being illustrative only, and should not be treated as limiting.

Turning back to the method of FIG. 1, after the resonance field's coherent peak(s) have been generated 102, the peak(s) may be used to provide 103 a result of the data processing. In some cases, this may be done straightforwardly by simply providing a peak as a result. For example, if the peak is a center-point of a dataset made up of measurements which are continuous across one or more dimensions, then the result may simply be a tuple with the value(s) of the dimension(s) at the center-point. However, in other cases, additional processing may be involved. For example, as shown in FIG. 7, in some cases (e.g., where the disclosed technology is used to process input comprising discrete tokens) a two-step process may be used when providing 103 an output. Such a process may begin with obtaining 701 an output waveform based on the resonance peak(s). In some cases, this step may be trivially accomplished through the generation 102 of the resonance field's peak(s) itself. For instance, if there was only a single peak (e.g., in an embodiment which used a method such as shown in FIG. 6 where the filtration 606 filtered out all but a single highest value resonance anchor), then the output waveform may simply be a waveform defined by that peak's frequency and offset. However, in a case where multiple peaks are identified (e.g., in an embodiment in which all resonance anchors with coherence values above a threshold are treated as peaks), a waveform output may be obtained 701 by combining them. Such a combination may be made by superimposing waveforms for each of the resonance anchors, but other approaches are also possible. For instance, in some cases, multiple peaks may be combined into a single waveform using calculations such as those of equation 16, below.

$$x ( t ) = Σ e \hat{} ( i \cdot {f}_{k} \cdot t ) \qquad Equation 16$$

In equation 16, x(t) is the output waveform (represented as a time domain function), and fₖ is the frequency for the k^{th} peak in the coherent resonance field. In some implementations, the phase offset of each peak resonance anchor (e.g., Δφₖ) may also be incorporated into the output waveform. This reflects the temporal alignment of the peak within the coherent structure. Accordingly, equation 16 may be modified as: x(t)=Σe\hat{ }(i·(fₖ·t+Δφₖ)). In this formulation, Δφₖ represents the phase offset for the k^{th} peak, and directly influences the initial condition and propagation trajectory of the resulting waveform. Including Δφₖ ensures that phase-coherent information encoded in the resonance field is preserved during output mapping, enabling more accurate reconstruction of structured meaning or signal pathways.

However it takes place, once the output waveform has been obtained 701, it can be converted 702 into a result. As with obtaining 701 the output waveform, in some cases converting 702 the output waveform to a result may be trivial. For example, in an application of the disclosed technology where the desired result is a waveform (e.g., in an implementation used for converting text into speech, or for converting one voice into another), the output waveform may be the result, meaning that the conversion 702 would be automatically completed when the output waveform is obtained 701. In other cases, the conversion 702 may be more involved. For instance, in some implementations, externally derived information may be used to semantically map an output waveform to a particular result. As an example of this, in an embodiment which used the disclosed technology to identify the emotional tone of recorded speech, the frequency of the output waveform may be directly converted into an emotional tone based on empirical research on that subject (see, e.g., Banse & Scherer, “Acoustic profiles in vocal emotion expression,” Journal of Personality and Social Psychology, 1996, which provides empirical mappings between pitch, intensity, and specific emotional tones, the disclosure of which is hereby incorporated by reference in its entirety).

Mappings based on factors other than external empirical research are also possible. For example, just as some implementations may convert input tokens to frequencies using a lookup table, some implementations may use a lookup table to convert a frequency of an output waveform to a token that could be provided as a result (e.g., by mapping the output waveform frequency to the closest frequency in the lookup table). Such a lookup table may be identical to a lookup table used for mapping input tokens to frequencies, but may also be different. For instance, if the disclosed technology was used to map natural language text to commands which might be provided to a control system, then a first lookup table may be used to map tokens from the natural language text to frequencies, and a second lookup table may be used to map an output waveform frequency to potential control system commands.

Non-frequency based approaches may also be used in some cases. For instance, it is possible that a conversion may be defined which maps an output waveform's chirality and phase (e.g., where an output waveform is defined by a single resonance anchor, these may be that resonance anchor's chirality tag and phase offset) to potential output tokens. For example, in a case where the disclosed technology was used to select from a set of n potential outputs (e.g., n words in a vocabulary, n commands to provide to a control system, etc.), those potential outputs may be mapped to potential phase and chirality combinations in a lookup table such as table 6, below, and that lookup table could be used to convert the phase and chirality of an output waveform to one of the potential outputs.

TABLE 6
Potential chirality and phase based lookup table

| Chirality | Phase | Output |
|---|---|---|
| L | [0, π/n/2] | Output 1 |
| L | [π/n/2, 2 * π/n/2] | Output 2 |
| L | [2 * π/n/2, 3 * π/n/2] | Output 3 |
| . . . | . . . | . . . |
| L | [(n/2 − 1) * π/n/2, n/2 * π/n/2] | Output n/2 |
| R | [n/2 * π/n/2, (n/2 + 1) * π/n/2] | Output n/2 + 1 |
| R | [(n/2 + 1) * π/n/2, (n/2 + 2) * π/n/2] | Output n/2 + 1 |
| . . . | . . . | . . . |
| R | [(n − 1) * π/n/2, n * π/n/2] | Output n |

Output generation may differ between implementations of the disclosed technology in other manners as well. To illustrate, consider FIG. 8, which illustrates a method in which a sequence of potential outputs may be considered holistically in order to provide a more coherent result. This type of method may be performed, for example, in an implementation where the disclosed technology is used to provide a natural language response to a natural language prompt, in much the same way that conventional large language models are often used today, though other types of holistic outputs (e.g., where the disclosed technology is used to generate a song comprising a sequence of musical notes) may also be generated using a process such as shown in FIG. 8. In this context, the method of FIG. 8 could begin by generating 801 a partial result, such as by identifying a highest coherence resonance anchor in a coherent resonance field and then converting that highest coherence anchor into a result token representing a word. A check 802 could then be made as to whether the partial result was a token indicating either that result generation should stop (e.g., because a complete response to the initial input prompt had been generated) or a token indicating that result generation should pause (e.g., because generation of a semantically coherent element of the result, such as a citation, had been completed). If the check 802 did not indicate that the result generation should stop or pause, then the partial result could be appended 803 to a sequence of results (e.g., by appending the most recently generated word onto a string of previously generated words), and a new partial result (e.g., a new word) could be generated 801. This could then continue until a partial result was generated which indicated that result generation should either stop or pause. When a partial result is generated which indicates that result generation should either stop or pause, a check 804 may be made of whether the sequence leading up to the generation of that partial result was acceptable. This may include application of a variety of filters, examples of which are described below.

A first filter which may be applied in evaluating a sequence leading to the generation of a partial result is to calculate the sequence's phase alignment score, which can be seen as checking that the internal logic of the system holds for the sequence being evaluated for emission. Then, once the phase alignment score has been calculated, it can be compared with an acceptability threshold. This may be done using PASₛ, PASₘ and/or PASₕ calculations of equations 3-5, though modified to apply to the sequence under consideration (e.g., by treating N as the number of elements in the sequence, rather than the number of neighboring anchors). In embodiments which include this type of filter, once a sequence's PAS has been calculated, that alignment can be compared with a threshold (e.g., a requirement that the value of PASₛ is greater than or equal to 0.85), thereby ensuring that it has at least a requisite phase alignment for being provided as a result.

Just as a sequence's phase alignment score can be used in its evaluation, in some implementations a global emission score may be calculated for a sequence and then used in its evaluation, either in addition to, or as an alternative to, the sequence PAS described above, and may be conceived of as a check of whether the emission is consistent with external global requirements. These calculations may be performed using equations 17-20, below, resulting in a global emission score representing a sequence's alignment and harmony both internally and relative to historical emissions.

$${H}_{k} = ( \frac{1}{N} ) * {\sum }_{j = 1}^{N} {\sum }_{i = 1}^{M} [ cos ( {θ}_{i} - {θ}_{j} ) * {c}_{i} * {c}_{j} * L ( {tag}_{i} , {tag}_{j} ) ] \qquad Equation 17$$

$${S}_{k} = ( \frac{1}{\vert {N}_{k} \vert} ) * {\sum }_{m ∈ {N}_{k}} [ cos ( {θ}_{k} - {θ}_{m} ) ) * {h}_{k} * {h}_{m} * L ( {tag}_{k} , {tag}_{m} ) \qquad Equation 18$$

$$GES = {\sum }_{k = 1}^{k = M} \frac{{PAS}_{k} * {H}_{k} * {S}_{k} * {θ}_{k}}{Z} \qquad Equation 19$$

$$GES = {GES}_{raw} * ( 1 - ( \frac{{I}_{count}}{{I}_{max}} ) ) \qquad Equation 20$$

In equations 17-20, Hₖ, θₖ, tagₖ, hₖ Cₖ and Sₖ are, respectively, a historical alignment value, the phase offset, the chirality tag, the harmonic compatibility coefficient, the coherence weight, and a structural harmony value for the k^{th} element in the sequence under consideration for emission. θᵢ, tagᵢ, and Cᵢ are, respectively, the phase offset, chirality tag and coherence weight for the i^{th} element in the sequence under consideration. θⱼ, tagⱼ, and Cⱼ are, respectively, the phase offset, chirality tag and coherence weight for the j^{th} element stored in a buffer of previously emitted outputs. L( ) is a function which takes two chirality tag values as input and outputs 1 if they are the same or 0 if they are different. N is the number of elements in a buffer of previously omitted outputs. Nₖ is the neighborhood (e.g., a 3×3 grid) of the k^{th} element in the sequence under consideration for emission. θₘ, tagₘ and hₘ are the phase offset, the chirality tag, and the harmonic compatibility coefficient of element m in the neighborhood Nₖ. M is the number of elements in the sequence under consideration, PASₖ is a local PAS for the k^{th} element in the sequence under consideration (e.g., as may be calculated using equations 3-5), and Z is a normalization constant which may be calculated as the sum of PASₖ*Hₖ*Sₖ for all elements in the sequence under consideration. I_{count} is a count of the number of iterations of the updating cycle of FIG. 6 which were performed prior to the output in question being defined, and Imax is a maximum number of such iterations which may be performed before the resonance field is deemed to be incoherent. GES_{raw} is an intermediate GES value which may be calculated for a sequence (e.g., using Equation 19) and used in the calculation of equation 20, which may be applied in implementations where a count is maintained of how many times an input has proceeded through the updating cycle of FIG. 6, and there is a maximum number of times such a cycle can be repeated before a field is declared to be incoherent. Once a GES has been calculated for a sequence, that score can be compared with a threshold, which threshold may be set to balance exclusion of decoherent emissions with retention of structurally novel sequences (e.g., a value on the range of 0.68 to 0.77). Using this approach, if the GES exceeded the threshold, then the sequence being evaluated may be considered to have passed the GES filter.

Another approach to sequence evaluation which may be used in some embodiments is applying a symmetry filter layer to validate structural coherence across the sequence under consideration based on each resonance anchor's compatibility with geometric and directional alignment criteria. This may include a directional symmetry alignment check which ensures adjacent anchors for the sequence under consideration exhibit consistent phase deltas (e.g., the difference in phase offsets between adjacent anchors for the sequence is no more than π/12, or such other value as may be tight enough to preserve alignment while still being flexible enough to avoid unnecessarily filtering natural variation) and chirality gradients. In this context, a chirality gradient may be considered as a pattern of change in chirality across a sequence. For example, a perfectly homochiral sequence (all Ls or all Rs) has a zero gradient. A gradient emerges when chirality switches occur across adjacent anchors. For example, a sequence with alternating L-R-L-R tags exhibits a high-frequency chirality gradient, while a sequence with mostly Ls and occasional Rs has a low-frequency gradient. Chirality gradients may be considered inconsistent when the number or spacing of tag switches exceeds a predefined threshold (e.g., more than two switches in a five anchor window), as this may indicate decoherence or structural instability in the field.

Other types of symmetry may also be considered when using a symmetry filter to validate structural coherence in some cases. For example, in some cases, a symmetry filter may be used to confirm either spatial and/or waveform symmetry, and a sequence may not be validated for emission unless at least one (or, in some cases, each) of the symmetries is present. In this context a “spatial symmetry” may be understood as geometric alignment of anchors across a defined grid (e.g., bilateral, axial, or radial consistency in anchor placement or orientation), and may be quantified as the average distance of anchors from the closest symmetric locations given the axes of symmetry in question. In this context, “Waveform symmetry” may be understood as referring to symmetry of mirrored periodic features in the anchor's temporal or frequency signature, and may be calculated as a mirror score using equation 21, below:

$$M = Σ \vert F ( {ω}_{k} ) - conj ( F ( - {ω}_{k} ) ) \vert / Σ \vert F ( {ω}_{k} ) \vert \qquad Equation 21$$

In that equation, M is the mirror score for the sequence under consideration. ωₖ is the waveform for the k^{th} token of the sequence under consideration. F(ωₖ) is the Fourier transform of the waveform for the k^{th} token of the sequence under consideration. conj(F(−ωₖ)) is the complex conjugate of the Fourier transform of the negative frequency waveform of the k^{th} token of the sequence under consideration. In this context, the numerator can be seen as computing an asymmetry energy, while the denominator normalizes the spectral energy of the waveform, providing a value which ranges from 0 (perfect mirror symmetry) to 1 (maximal asymmetry).

There may also be an emission verification in which the sequence would be validated as matching a known coherent template stored in a phase memory buffer. A phase memory buffer is a structured memory construct that stores recently validated coherent sequences, including their anchor-level phase values, chirality tags, and resonance scores. In implementations where such a buffer is present, the recently validated coherent sequences may be treated as templates, and to match them the sequence under consideration may be evaluated to confirm that it exhibits phase alignment (e.g., the average phase offset of the sequence under consideration is within a threshold amount of the average phase offset of the sequence in the buffer), chirality continuity (e.g., the dominant chirality of the sequence under consideration is the same as the dominant chirality of the sequence in the phase memory buffer), and harmonic completeness within a tolerance window. In this context, confirming that two sequences exhibit harmonic completeness may be performed using a method such as shown in FIG. 16.

FIG. 16 illustrates a method which may be used to determine if each token in a sequence which is being validated for emission exhibits frequency alignment with one or more comparison tokens in a previously validated sequence. Initially, in the method of FIG. 16, a set of comparison tokens is identified 1601. In some cases, this may be done simply by identifying the token in a previously stored sequence which is at the same position as the token under consideration in the sequence being validated for emission (e.g., the k^{th} token in the sequence being validated and the k^{th} token in the previously stored sequence). In other cases, a more flexible approach, such as a sliding window approach (e.g., in which the comparison tokens for the k^{th} token in the sequence being validated could be the k^{th} token and the n tokens on either side of the k^{th} token in the previously stored sequence). However it is done, once the comparison token(s) had been identified 1601, a check 1602 may be performed to determine if there is a frequency match with the token under consideration. This check 1602 may be treated as satisfied (i.e., there is a frequency match) if the frequency of the token under consideration is the same (within some tolerance, such as 3%) as the frequency of at least one of the comparison token(s). Alternatively, if there is no frequency match, then a further check 1603 may be performed of whether there is harmonic congruence between the token under consideration and the comparison token(s). This check 1603 may be treated as satisfied if the frequency of the token under consideration is a whole number multiple (again, within a tolerance) of one or more of the comparison token(s), or vice versa. If either of those checks is satisfied, then the token under consideration may be treated as exhibiting frequency alignment, otherwise, no frequency alignment would be found. The results for each of the tokens in the sequence being validated for emission may then be combined, and if 80% or more of them exhibited frequency alignment, then the sequence under consideration may be seen as having harmonic completeness relative to the previously validated sequence from the phase memory buffer.

Another approach which may be used to validate a sequence based on its relationship to a previously validated sequence in a phase memory buffer is to evaluate inter-sequence structural integrity, such as using an equation like equation 22, below.

$${SI}_{s} = ( Σ {\vert Δ {φ}_{k} \vert}^{- 1} \times {M}_{k} ) / n \qquad Equation 22$$

In that equation, SIₛ is a structural integrity score for sequence s, Δφₖ is the phase delta across adjacent anchors for the k^{th} anchor in the sequence), Mₖ is a memory match coefficient for the k^{th} element in the sequence under consideration, and n is the number of elements in the sequence under consideration. Mₖ is calculated by measuring the degree of similarity between the current anchor's attributes (Δφ, C_{tag}, pₖ, etc.) and those of corresponding anchors in stored phase memory templates. A cosine similarity function may be applied across attribute vectors, and weighted by time-decay or recency. A high Mₖ (>0.85) suggests structural resonance echo from prior high-fidelity emissions. This structural integrity score can be compared with a threshold (e.g., 0.81 or other value which may be used to filter noisy or decoherent sequences), and only sequences with scores greater than that threshold would be treated as matching a sequence in the phase memory buffer (and therefore being treated as validated by virtue of that match).

Another approach which may be used to evaluate 804 a sequence for emission is to calculate a resonance score for that sequence. Equations which may be used for this calculation are provided below as equations 23-27.

$${χ}_{s} = ( {L}_{max} ) / n - p * S \qquad Equation 23$$

$${G}_{s} = 1 - {\sum }_{k = 1}^{M} \frac{\vert {ctag}_{k} - {ctag}_{mean} \vert}{M} \qquad Equation 24$$

$${G}_{s} = 1 / \vert E \vert * {\sum }_{( i , j ) ∈ E} [ L ( {Ctag}_{i} , {Ctag}_{j} ) * cos ( {θ}_{i} - {θ}_{j} ) ] \qquad Equation 25$$

$${H}_{s} = \frac{1}{B} * {\sum }_{b = 1}^{B} {δ}_{b} \qquad Equation 26$$

$${R}_{s} = {w}_{1} * {G}_{s} + {w}_{2} * {χ}_{s} + {w}_{3} * {H}_{s} \qquad Equation 27$$

In those equations, χₛ, Gₛ, Hₛ, and Rₛ are, respectively, chiral continuity, spatial symmetry, harmonic completeness, and resonance values for sequence s, where sequence s is the sequence being evaluated for omission. Lₘₐₓ is the longest homochiral run in sequence s. n is the number of anchors in sequence s. S is the number of chirality switches in sequence s, and p is a penalty constant (e.g., 0.1) applied when there is a chirality switch between adjacent tokens in sequence s. w₁-w₃ are application-specific weights, which may be determined based on the context in which the disclosed technology is being used (e.g., w₂ may be dominant in emotional resonance systems, while w₁ may be prioritized in waveform anomaly detection). Ctagₖ is the chirality tag for the k^{th} element of the sequence being evaluated for emission, encoded as +1 for L and −1 for R. Ctagₘₑₐₙ is the average chirality for the sequence being evaluated for emission. θᵢ and θⱼ are the phase offsets for the i^{th} and j^{th} elements in the sequence being evaluated for emission. E is a set of adjacent anchor pairs, and is part of equation 25, which may be used as an alternative to equation 24 in cases of higher density coherent grids. L( ) is a function which takes two chirality values as input, and returns either 1 (if the values are the same) or 0 (if the values are different). B is a number of frequency buckets for organizing the coherent resonance grid containing the peak(s) used to generate the sequence being evaluated, and may be equal to the result of performing integer division on the maximum frequency of a prime resonance anchor in the grid by a minimum frequency of a prime resonance anchor in the grid. δ_{b} is one if the sequence under consideration has at least one anchor in frequency bucket b with a coherence weight (attribute Cₖ from table 2) which exceeds a minimum coherence threshold (e.g., 0.3), and zero otherwise.

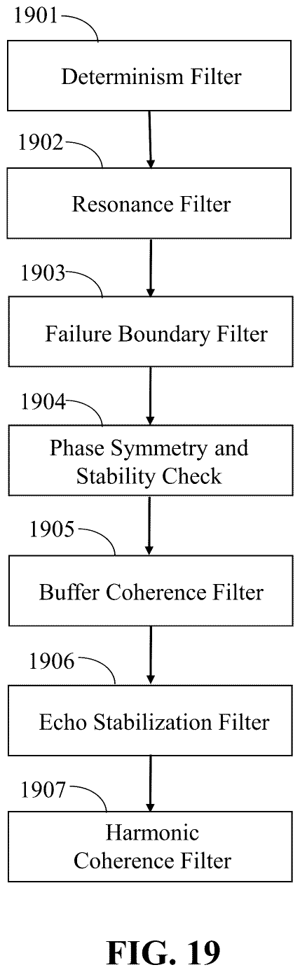

Other evaluation approaches are also possible, and may be applied in some implementations. For example, FIG. 19 illustrates a “legality stack” which is a sequence of filters which may be applied to one or more outputs to determine 804 if it is/they are acceptable, either in addition to, or as an alternative to, one or more of the checks described above. In an embodiment following FIG. 19, the first filter of the legality stack would be a determinism filter 1901, which could be applied by re-processing the inputs which led to the output under consideration multiple times, and verifying determinism by checking if the variance of relevant metrics (e.g., phase offset of a coherent peak which was used to derive the output) of the outputs which were generated each time was zero (or below some threshold, if small discrepancies could be treated as acceptable). If the determinism filter 1901 was passed, then a resonance filter 1902 may be applied, such as by ensuring that a value of drift relative to a most recently approved output did not exceed a resonance threshold (e.g., a value between 0.03 and 0.07). In such a case, the value of drift relative to the most recently approved output (e.g., the most recently approved sequence) may be calculated using calculations such as equation 28, below.

$$Δ {PAS}_{rel} = \vert {PAS}_{1} - {PAS}_{2} \vert \qquad Equation 28$$

In that equation, ΔPASᵣₑₗ is the value of drift relative to the most recently approved output. PAS₁ is a PAS value for the output under consideration, and PAS₂ is a corresponding PAS value for the most recently approved output.

A third filter which may be applied as part of a legality stack in an implementation following FIG. 19 is a failure boundary filter 1903. This filter may comprise evaluating if the absolute value of difference between PAS values for two time steps of the output (e.g., the difference between the PAS value for the resonance field used to derive the output at the time the output was generated, and the PAS value for the resonance field used to derive the output at the time step prior to the output being generated; the difference between the PAS value for an output sequence under consideration, and the PAS value for that sequence as it existed prior to its most recently added element being added, etc.) was greater than a threshold amount (e.g., 0.05 if the PAS value being used is PASₛ, or 0.02 if the PAS value being used is ΔPAS_{ζ}). If the difference was greater than the threshold, then the output under consideration may be treated as having failed the failure boundary filter 1903. Otherwise, evaluation of the legality stack may continue.

Following the failure boundary filter 1903, and assuming that the output under consideration had passed all relevant checks, an implementation following the legality stack of FIG. 19 could continue with a phase symmetry and stability check 1904, which may entail applying one or more symmetry filters such as those described previously in the context of chirality gradient evaluation. This may be followed by application of a buffer coherence filter 1905, which may involve calculating mean PAS values for the resonance field that led to the output under consideration over a predefined time window (x̅_{buffer}), as well as a standard deviation of those values (σ_{buffer}). The buffer coherence filter 1905 may be then be treated as not being satisfied if either the mean is less than a minimum value or the standard deviation is greater than a maximum value, thereby ensuring that the resonance field which lead to the output is not only phase aligned, but that its phase alignment remains stable over time.

A legality stack in an implementation following FIG. 19 may also include an echo stabilization filter 1906. In this filter, the anchors for one or more past outputs (e.g., previous partial results in the sequence under consideration) may be inserted into the resonance field from which the current output was obtained. That resonance field may be brought into coherence, a new peak identified, and a new output waveform obtained. The new output waveform may then be cross correlated with the waveform for the output under consideration. If the cross-correlation exceeded a pre-defined minimum correlation (e.g., a value between 0.85 and 0.92), and the value of ΔPAS; for the output under consideration relative to the past output was less than or equal to an echo constant (e.g., 0.02), then the echo stabilization filter may be treated as being satisfied for the output under consideration. Finally, a harmonic coherence filter 1907 could be applied, which would be treated as satisfied based on whether a PASₕ value for the sequence under consideration exceeded a minimum threshold value (e.g., PASₕ>0.85).

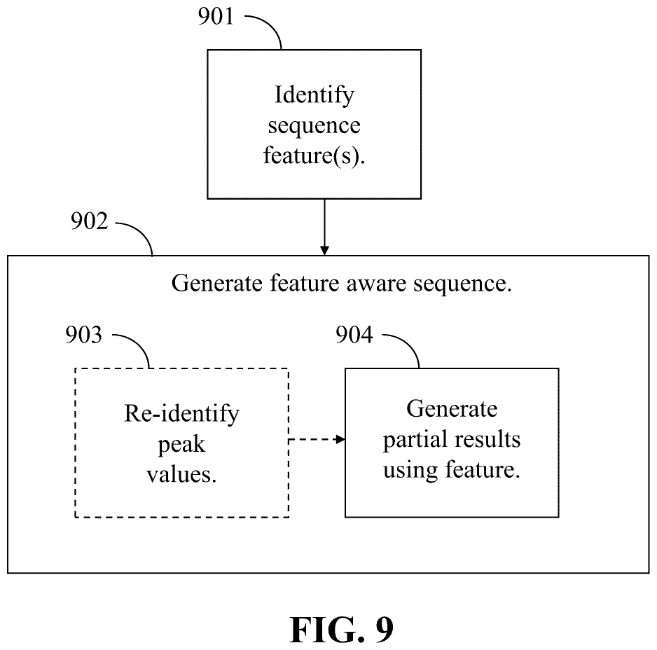

Continuing with the discussion of FIG. 8, whatever types of considerations are included in evaluating 804 a sequence of partial results, if a sequence was evaluated 804 as being acceptable, then it may be outputted 805 as a result (e.g., a sequence of words may be displayed on a screen in a response to a prompt) and may also be stored in a phase memory buffer (if such a buffer is present in the implementation in question). Additionally, if the partial result which led to the sequence's evaluation was a token which indicated that processing should stop, then the process may terminate 806, with the most recently output sequence, together with any previously approved sequences, being the result for the relevant input. Otherwise, the process may iterate, with further partial results being generated 801, and further sequences being evaluated 804 until a complete result was ultimately provided. Alternatively, if the evaluation 804 indicates that the sequence under consideration is not suitable for being included in a result, then the process of FIG. 8 may proceed to remediation 807 for that sequence. An example of what this remediation may entail is provided below in the context of FIG. 9.

As shown in FIG. 9, remediation 807 of a result sequence which was found to be unacceptable may begin with identifying 901 a feature in the sequence which led to its rejection. This may be done, for example, by comparing the parameter values used in evaluating the sequence with predetermined acceptable values for those parameters (e.g., values which had been calculated for a large number of sequences which were successful on their evaluations), and identifying parameter values for the rejected sequence which were significantly (e.g., differ by one or more standard deviations) below the acceptable values. After the feature(s) which led to the rejection had been identified 901, a new sequence may be generated 902 in a manner which accounts for those features. In some cases, this may involve re-identifying 903 the peak values in a coherent resonance field. For example, in a case where the sequence being remediated was based on results derived from the highest coherence resonance anchors in a coherent resonance field, remediation may involve re-identifying the peaks to be not just the highest value anchors, but any anchors which had coherence values above a threshold, so that there could be choices made between potential partial results when generating the 902 the feature aware sequence. The generation 902 of a feature aware sequence could then proceed with in the same manner as described previously for FIG. 8 (generating partial results and appending them to a sequence until a stop or pause was encountered), except that the generation of the feature aware sequence could use the identified features when generating 904 partial results. For example, in some cases when generating 904 the partial results for a feature aware sequence, the feature(s) which led to the original sequence rejection could be used as factors for deciding between different partial results (e.g., if the original rejection had been based in part on chirality shifts, then a potential partial result which maintained the sequence's chirality could be given preference relative to a potential partial result which did not).

As another example of how remediation 807 may be implemented, in some cases, when no result which is suitable for emission is identified after initial generation attempts, the system may hold one or more partially generated sequences in a temporary buffer for deferred reprocessing. In such cases, the sequence is not emitted immediately, but preserved in memory while the system continues to generate additional partial results or re-evaluate the resonance field. If subsequent inference cycles yield higher coherence anchors, the deferred sequences may be re-evaluated under the improved alignment conditions. This approach is particularly relevant in systems with structured resonance substrates or multi-modal input domains, where transient decoherence can obscure viable results which may later meet emission thresholds under updated field context. For example, consider a multi-modal inference system tasked with generating a descriptive caption from both an image and a sound waveform (e.g., a child laughing while playing with a red balloon in a park). Suppose the initial inference cycle captures partial results from the image suggesting “child” and “red object,” but the sound input introduces transient dissonance due to background noise, lowering overall PAS below the emission threshold. Rather than discarding the result, the system buffers the candidate sequence “A child with a red . . . ” and continues evaluating the input stream. On the next inference cycle, improved sound-source localization identifies high-coherence laughter anchors aligned with the child in the visual frame, increasing phase alignment across modalities. The buffered sequence is then re-evaluated under this updated resonance context, now scoring above threshold, and finalized as: “A child laughing while holding a red balloon.” This illustrates how deferred re-evaluation allows structurally valid but initially obscured results to surface once coherence context stabilizes.

Other approaches to remediation 807 are also possible, and may be used in some cases. For example, in some embodiments, when a sequence of partial results is being created, one or more alternate sequences may also be created, and remediation 807 may include switching to an alternate sequence, rather than generating a new factor aware sequence as described above in the context of FIG. 9. To illustrate, consider a case where the identification 605 of peak values included identification of one peak value having a ‘L’ chirality tag, and one peak value having an ‘R’ chirality tag. In such a case, the generation and appending of partial results may be used to create three sequences: a sequence made of the partial results with the highest coherence scores regardless of chirality, a sequence made of partial results with the highest coherence scores and ‘L’ chirality, and a sequence made of partial results with the highest coherence scores and ‘R’ chirality. Then, when evaluating 804 the sequences, first the sequence with the highest coherence score regardless of chirality may be evaluated, with remediation 807 being performed by switching to one of the other two sequences if the first sequence failed its evaluation. Other approaches, such as terminating processing and treating whatever sequences had already been provided as output as the final results (or, if no sequences had already been provided, then providing a default, such as “I don't know” when the disclosed technology was used to implement a chatbot or similar natural language response system) when remediation had not resulted in an acceptable sequence a predetermined number of times) are also possible, and may be used in some cases. Accordingly, the remediation examples provided above, like the other examples set forth in this document, should be understood as being illustrative only, and should not be treated as limiting.

It should be understood that variations are also possible in aspects other than approaches to remediation. For instance, in some embodiments implementing methods such as shown in FIG. 8, partial results may always be generated in a factor aware manner—e.g., factors which could potentially result in a sequence being rejected, such as chirality switches, could be considered when partial results are initially generated, rather than only considering such factors as part of remediation. Similarly, while the legality stack of FIG. 19 was introduced in the context of FIG. 8, it should be understood that, in some cases, such a legality stack may be applied whenever an output is generated, such as by applying the legality stack to a non-sequential output and remediating that output if one or more of the legality stack's filters was not satisfied. It is also possible that, in some cases, output controls beyond filtering and remediation may be applied. For example, some embodiments may only allow an output to be emitted at times τ satisfying τ∈{p*T_{base}±δ_{τ}}, where p is any prime, T_{base} is a base tick (e.g., 10 ms), and δₜ is a timing tolerance (e.g., ≤0.2 ms). This may be done in cases where some delay is beneficial to avoid race conditions being generated or to align outputs with actions (e.g., updates) in systems or modules which would consume them.

Variations are also possible in processing performed to bring 601 a resonance field into a coherent state. For example, in some cases, only highly deviant anchors (e.g., those anchors with the highest coherence deltas) will be updated 603, rather than the updating 603 including all anchors in the resonance field. As another example, it is also possible that, when updating 603 a resonance field, anchors may be repositioned within the resonance field, rather than simply having their attribute values changed. This may be the case, for example, when a resonance field has dimensions which are defined by anchor attributes, and an anchor is updated such that an attribute corresponding to a dimension is changed. Additional potential changes which may be made when updating 603 anchors in a resonance field are also possible. For instance, in some cases, an anchor's coherence weight may be modified as part of updating 603 a resonance field. This may be done, for example, using an equation such as equation 29, below, which updates a coherence weight value based on an anchor's phase offset.

$${C}_{new} = {C}_{old} - β * \vert Δ φ \vert \qquad Equation 29$$

In that equation, C_{new} is the new coherence weight (i.e., attribute Cₖ from table 2) of the anchor being updated, C_{old} is the old coherence weight of the anchor being updated, Δφ is the phase offset of the anchor being updated, and β is a stabilization constant such as a value from 0.01 to 0.05, with lower values being used in high-stability fields and higher values being used when rapid convergence is prioritized.

As a further example of a variation in bringing a resonance field into a coherent state, in some cases, rather than ensuring that a phase delta is below a threshold, a positive threshold may be used, such as calculating an overall coherence score for a resonance field, using an equation such as equation 30, below, and then validating that that overall coherence score was above a coherence threshold (e.g., above 0.91).

$$C = ( 1 / N ) * Σ [ {w}_{k} / ( {Δφ}_{k} + ε ) ] \qquad Equation 30$$

In that equation C is the overall coherence score for the prime encoded resonance field, N is the number of anchors in the prime encoded resonance field, wₖ is a harmonic weight (e.g., the harmonic compatibility coefficient from the exemplary data structure of table 2) for the k^{th} anchor in the field, Δφₖ is the phase delta for the k^{th} anchor in the field, and ε is a stabilizing constant (e.g., ε=0.01) introduced to prevent division by near-zero Δφₖ values and to normalize sensitivity in sparse anchor configurations (e.g., configurations in which a resonance field has a small number of anchors which contribute disproportionately, such as because they have particularly low phase deltas).

Variations are also possible in aspects beyond how features such as described above may be implemented. For example, in some embodiments, when a potential output sequence cannot pass one or more filters (e.g., as described in the context of the sequence evaluation 804 of FIG. 8), or when a resonance field cannot be brought into a coherent state, then the sequence or decoherent field may be stored, along with associated metadata (e.g., the input which led to the decoherent/unacceptable state) for subsequent analysis and potential updating of the system. As another example, in some embodiments, when a resonance field is being brought into a coherent state, the values of the locations making up that field may be displayed for a user, allowing him or her to see the changes bringing the field into coherence in real time. Additional steps may also be added. For instance, in some cases, before beginning an updating cycle such as illustrated in FIG. 6 for bringing 601 a resonance field into a coherent state, a check may be performed of whether an input appears to have the potential for generating a coherent resonance field suitable for emitting outputs (e.g., checking text provided as a prompt for natural language processing is itself meaningful). This may be done by evaluating a series of conditions, such as the chirality and coherence conditions laid out in equations 31 and 32, and only proceeding with bringing 601 the field into a coherent state if the evaluation indicated that doing so would be likely to be successful (e.g., both of the conditions represented by equations 31 and 32 were satisfied).

$$\vert {N}_{L} - {N}_{R} \vert / ( {N}_{L} + {N}_{R} ) < ε \qquad Equation 31$$

$$\frac{{\sum }_{k = 1}^{N} {c}_{k}}{N} \geq {C}_{thresh} \qquad Equation 32$$

In those equations N_{L} and N_{R} are, respectively, the number of left and right chirality anchors for the input in question. ε is a symmetry constant (e.g., 0.25) which can be used to confirm that the anchors' chirality is balanced to within a specified tolerance. N is the number of anchors derived from the input, Cₖ is the coherence weight for the k^{th} anchor, and Cₜₕᵣₑₛₕ is a minimum coherence threshold (e.g., 0.6) which can be applied to evaluate the input.

Another type of variation which may be present in some cases is variation in the structure of the resonance field itself. For example, as described previously in the context of FIG. 4, a resonance field may be subdivided into a grid consisting of square tiles having integer values arranged in a spiral pattern. However, even in implementations which follow the square grid-structure of FIG. 4, variations are possible, such as arranging integer values according to a Hilbert curve, rather than in a spiral pattern. Further, in some cases, the implementation of a resonance field may vary in other ways, such as dividing it into regions having shapes other than the square grid shown in FIG. 4 (e.g., dividing the field into triangular regions, hexagonal regions, etc.). It is also possible that a resonance field may be implemented which does not use explicit subdivisions at all, such as representing a resonance field as an n-dimensional space with concepts such as a neighborhood being reflected in distance measures rather than adjacency of regions as described previously. The anchors which are used to populate a resonance field may also vary. For example, while table 2 illustrated example attributes which may be used to define a resonance anchor, other attributes may also be used in some cases. For instance, in a case where the disclosed technology is used to analyze EEG waveforms, anchors corresponding to those waveforms may include attributes for cortical regions, and those cortical regions may be used to define one or more dimensions in a resonance field populated with those anchors.

Embodiments may also differ from one another in the organization of processing relative to input/output consumption/production. For instance, in some embodiments, a method such as illustrated in FIG. 1 may proceed in a purely stepwise manner, with all input consumed and used to derive 101 prime resonance anchors, followed by coherence peaks being generated 102 in a resonance field based on those anchors, followed by those peaks being mapped 103 to a result. However, in other embodiments, similar processing may proceed in an interleaved or otherwise temporally dynamic fashion. For instance, in a case where the disclosed technology was being used to process temporally varying inputs, additional input may be incorporated into ongoing processing as it is received, rather than waiting for processing on one input to complete before processing on another input could begin. To illustrate, consider that, when processing EEG waveforms, a resonance field based on an initial input (e.g., 1 second of EEG waveforms) may still be in the process of being brought into a coherent state when an additional input (e.g., another second of EEG waveforms) is provided. When this happens, it is possible that the resonance field which was already being processed may be updated based on the additional input. For instance, a phase for an anchor corresponding to a particular signal may be updated based on the additional information provided for that signal. In cases where this type of temporally dynamic processing takes place, the updating may be performed by updating the values originally assigned to a parameter (e.g., a phase offset value may be updated by recalculating the offset based on the newly provided information for an EEG signal), or additional parameters may be included in anchors to reflect temporally dynamic input (e.g., attributes such as those shown in table 2 may be augmented with a θₖ parameter, representing the dynamically varying phase difference between the input signal and the frequency anchor).

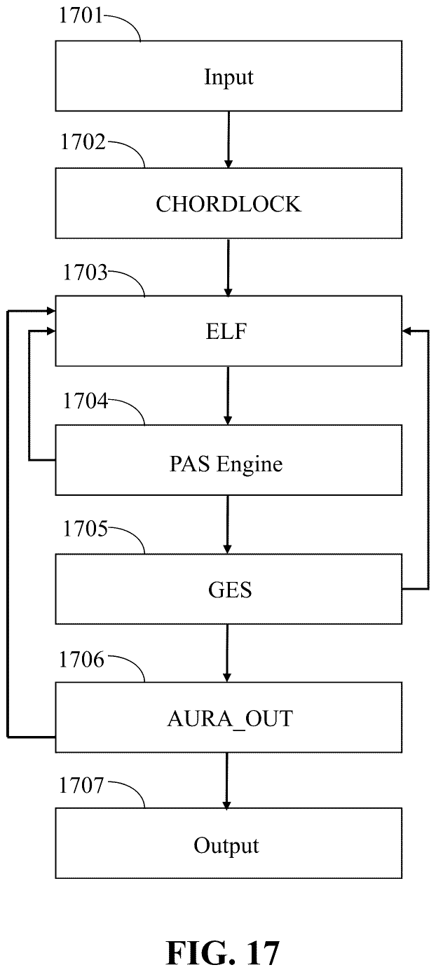

Implementations may also differ in terms of organization for logic implementing the disclosed processing steps. For example, in some cases, the disclosed technology may be implemented using a layered architecture, in which code for particular tasks or sets of tasks is localized, such as into dedicated modules. An example this type of layered architecture is shown in FIG. 17. In that architecture, an input layer 1701 could be used to provide one or more input interfaces (e.g., application programming interface(s), graphical or text based user interface(s)), and to convert inputs provided via those interfaces into a form suitable for processing by the remainder of the system (e.g., converting an input into resonance anchors and defining the attributes of those anchors, as described previously in the context of FIGS. 1-3). An additional layer, referred to as a CHORDLOCK (Coherence Harmonic Ordered Resonance Domain Locator) layer 1702 in FIG. 17 could then be used to use the anchors to populate the prime resonance field and could also validate that the prime resonance field is likely to become coherent (e.g., by performing acts as described previously in the context of FIGS. 4-5 and 12-13). The actual process of bringing the resonance field into a coherent state (e.g., by performing acts as described in the context of FIGS. 6 and 14-15) could then be performed using the layer 1703 labeled as ELF (Error Limiting Feedback) in FIG. 17. Exemplary code which may be used in implementing such an ELF layer is provided in tables 7-8, below.

TABLE 7
Exemplary ELF declaration code.

```
// ELF.h − Error-Limiting Feedback Controller (Declaration)
#ifndef ELF_H
#define ELF_H
#include <vector>
#include <complex>
class ELF {
private:
  std::vector<std::complex<double>>* phase_ref;
  std::vector<int> primes;
public:
  ELF(std::vector<std::complex<double>>* data_ptr, const std::vector<int>& p);
  void deltaPhase(double time, double pos);
  void adaptToNoise(double noise_factor);
  void trackPASDrift(double target_pas, double (*pas_fn)(double, double), double time,
double pos);
};
#endif
```

TABLE 8
Example ELF implementation code, including micro-corrections,
noise suppression, and phase alignment score drift tracking.

```
// ELF.cpp − Error-Limiting Feedback Controller (Implementation)
#include “ELF.h”
#include <cmath>
ELF::ELF(std::vector<std::complex<double>>* data_ptr, const std::vector<int>& p)
  : phase_ref(data_ptr), primes(p) { }
void ELF::deltaPhase(double time, double pos) {
  for (size_t i = 0; i < phase_ref−>size( ); ++i) {
    double fp = 2 * M_PI * log(primes[i]);
    double chi = (i % 2 == 0 ? 1 : −1) * log(primes[i]);
    double theta = fp * time + chi * pos;
    double error = std::arg((*phase_ref)[i]) − theta;
    if (std::abs(error) > 0.05) {
      (*phase_ref)[i] *= std::polar(1.0, −0.005 * error);
    }
  }
}
void ELF::adaptToNoise(double noise_factor) {
  for (auto& amp : * phase_ref) {
    double phase = std::arg(amp);
    amp *= std::polar(1.0, −noise_factor * phase); // Suppress resonance diffusion
  }
}
void ELF::trackPASDrift(double target_pas,
        double (*pas_fn)(double, double),
        double time,
        double pos) {
  double current_pas = pas_fn(time, pos);
  double drift = target_pas − current_pas;
  if (std::abs(drift) > 0.01) {
    adaptToNoise(drift * 0.05); // Feedback stabilizer for long-term alignment
  }
}
```

In an implementation following FIG. 17, an ELF layer 1703 may make calls to another layer, identified in FIG. 17 as a PAS engine 1704, while bringing a field into a coherent state and then determining peak values for the field. Such a PAS engine 1704 may perform phase alignment score calculations such as described herein, and may potentially be invoked by other modules (e.g., an AURA_OUT module 1706) in addition to an ELF layer 1703 as described. Similarly, an implementation of the disclosed technology may also include a GES module 1705, which could perform a global check on a resonance field that appeared suitable based on phase alignment (e.g., using equation 13) or on a sequence which was a candidate for emission (e.g., using equation 20). Further checks (e.g., symmetry, resonance and/or integrity checks, such as described in the context of evaluating 804 sequences for emission) may be performed using an AURA_OUT (Aesthetic and Unitary Resonance Alignment Output) module 1706, such as may be implemented using the exemplary code set forth in tables 9 and 10, below.

TABLE 9
Example AURA_OUT declaration code for aesthetic
and alignment-filtered signal output.

```
// AuraOut.h − Output Coherence Filter (Declaration)
#ifndef AURA_OUT_H
#define AURA_OUT_H
#include <vector>
#include <complex>
#include <functional>
class AuraOut {
private:
  std::vector<std::complex<double>>* signal_ref;
  double pas_cutoff;
  double aesthetic_threshold;
public:
  AuraOut(std::vector<std::complex<double>>* sig_ptr,
    double pas_limit = 0.92,
    double aesthetic_limit = 0.85);
  bool isOutputLegal(double pas_val, double symmetry_score) const;
  void emitIfAligned(double pas_val, double symmetry_score,
      const std::function<void( )>& emit_callback);
};
#endif
```

TABLE 10
Example AURA_OUT Implementation code.

```
// AuraOut.cpp - Output Coherence Filter (Implementation)
#include “AuraOut.h”
AuraOut::AuraOut(std::vector<std::complex<double>>* sig_ptr,
        double pas_limit,
        double aesthetic_limit)
  : signal_ref(sig_ptr),
    pas_cutoff(pas_limit),
    aesthetic_threshold(aesthetic_limit) { }
bool AuraOut::isOutputLegal(double pas_val, double symmetry_score) const {
  return (pas_val >= pas_cutoff) && (symmetry_score >= aesthetic_threshold);
}
void AuraOut::emitIfAligned(double pas_val,
          double symmetry_score,
          const std::function<void( )>& emit_callback) {
  if (isOutputLegal(pas_val, symmetry_score)) {
      emit_callback( ); // Approve output
  } else {
      // Suppress output or log structural incoherence
  }
}
```

After an output had satisfied all applicable checks applied by a PAS engine 1704, a GES module 1705 and an AURA_OUT module 1706, that output may be emitted by an output layer 1707. This output layer 1707 may be responsible for formatting output for emission, as well as for actually providing the output to its recipient, such as to a consuming process via an API, or to a user via a user interface.

It should be understood that, while FIG. 17 and the associated text described how code for the disclosed technology could potentially be organized, that figure and its associated discussion are intended to be illustrative only, and variations are possible. For example, while FIG. 17 illustrated an AURA_OUT module 1706 as directly preceding the output layer 1707, in some implementations, there may be other, or different, filters applied, either before or after those which may be associated with an AURA_OUT module 1706. For instance, in some cases, prior to emission, an additional module may be invoked which could insert an output sequence into a resonance field which had been previously validated as providing coherent peaks for outputs which had been deemed to be ethical in the emission's domain, and whether the output sequence generated coherent peaks in the previously validated ethical resonance field may be used as a test to ensure that outputs satisfied ethical constraints, in addition to being coherent and satisfying any other checks which may be applied in a particular case. It is also possible that some implementations may use code which is organized in manners other than that illustrated in FIG. 17. To illustrate, consider tables 11-14, which provide code for classes which combine functionality illustrated in FIG. 17 as being spread across the ELF layer 1703, PAS Engine 1704 and GES module 1705, as well as tables 15 and 16, which illustrate how the classes from tables 11-14 could be used in a particular artificial intelligence implementation.

TABLE 11
Example of declaration code for the illustrative ResonanceData class.

// ResonanceData.h - Declaration of Resonance-Based Data Structure
#ifndef RESONANCE_DATA_H
#define RESONANCE_DATA_H
#include <complex>
#include <vector>
#include <cmath>
class ResonanceData {
private:

| | |
|---|---|
| std::vector<std::complex<double>> data; | // Prime-anchored complex amplitudes |
| std::vector<int> primes; | // Prime indices (p_k) |
| double coherence_threshold; | // Global coherence gating threshold (C_n) |

```
public:
  ResonanceData(const std::vector<double>& input, const std::vector<int>& p);
  void phaseAlign(double time, double position); // Aligns data in (x, t) space
```

| | |
|---|---|
| double computeCn( ); | // Computes C_n: alignment-level coherence score |
| double computePAS( ); | // Computes PAS: phase alignment alignment signal |

std::vector<std::complex<double>> getData( ) const; // Returns internal resonance vector
};
#endif

TABLE 12
Example implementation code for the illustrative ResonanceData class.

```
// ResonanceData.cpp - Implementation
#include “ResonanceData.h”
#include <algorithm>
ResonanceData::ResonanceData(const std::vector<double>& input,
          const std::vector<int>& p) :
  primes(p), coherence_threshold(1.0) {
  data.resize(input.size( ));
  for (size_t i = 0; i < input.size( ); ++i) {
```

| | |
|---|---|
| double fp = 2 * M_PI * log(primes[i]); | // Prime frequency |
| double chi = (i % 2 == 0 ? 1 : −1) * log(primes[i]); | // Chiral phase |

data[i] = input[i] / primes[i] *

| | |
|---|---|
| std::complex<double>(cos(chi), sin(chi)); | // Resonance encoding |

```
  }
}
void ResonanceData::phaseAlign(double time, double pos) {
  for (size_t i = 0; i < data.size( ); ++i) {
    double fp = 2 * M_PI * log(primes[i]);
    double chi = (i % 2 == 0 ? 1 : −1) * log(primes[i]);
    double theta = fp * time + chi * pos;
    double error = std::arg(data[i]) − theta;
    // Insert ELF-style feedback loop logic
    if (std::abs(error) > 0.1) {
      data[i] *= std::polar(1.0, −0.01 * error);
    }
  }
}
double ResonanceData::computeCCS( ) {
  double peak_sum = 0.0, off_sum = 0.0;
  for (size_t i = 0; i < data.size( ); i += 2) {
```

| | |
|---|---|
| peak_sum += std::norm(data[i]); | // Even-index resonance peaks |

```
  }
  for (size_t i = 1; i < data.size( ); i += 2) {
```

| | |
|---|---|
| off_sum += std::norm(data[i]); | // Odd-index off-peaks |

```
  }
  return (off_sum > 0) ? peak_sum / off_sum : 1.0;
}
// Inserted: Local alignment metric for PAS-based subsystems
double ResonanceData::computePAS( ) {
  double total_phase_error = 0.0;
  for (size_t i = 0; i < data.size( ); ++i) {
    double fp = 2 * M_PI * log(primes[i]);
    double chi = (i % 2 == 0 ? 1 : −1) * log(primes[i]);
    double expected_phase = fp + chi;
    double actual_phase = std::arg(data[i]);
    total_phase_error += std::abs(expected_phase − actual_phase);
  }
```

| | |
|---|---|
| return 1.0 / (1.0 + total_phase_error); | // Higher = more aligned |

}
std::vector<std::complex<double>> ResonanceData::getData( ) const {
return data;
}

TABLE 13
Example of Declaration of an illustrative PSRE
class for structured resonance convergence.

```
// PSRE.h - Prime Structured Resonance Engine (Declaration)
#ifndef PSRE_H
#define PSRE_H
#include <vector>
#include <complex>
class PSRE {
private:
  std::vector<std::complex<double>> phase_data;
  std::vector<int> primes;
  double c_n_cutoff; // Global ignition threshold (C_n)
public:
  PSRE(const std::vector<std::complex<double>>& input,
    const std::vector<int>& prime_indices,
    double cutoff = 0.999);
  double getPAS(double time, double pos) const;
  double getC_n( ) const;
  bool isIgnitionReady( ) const;
  void phaseSweep(double t_start, double t_end, double pos);
};
#endif
```

TABLE 14
Example of Implementation of the PSRE class, providing
PAS, Cₙ, and coherence validation logic.

```
// PSRE.cpp - Prime Structured Resonance Engine (Implementation)
#include “PSRE.h”
#include <cmath>
#include <numeric>
PSRE::PSRE(const std::vector<std::complex<double>>& input,
      const std::vector<int>& prime_indices,
      double cutoff)
  : phase_data(input), primes(prime_indices), c_n_cutoff(cutoff) { }
double PSRE::getPAS(double time, double pos) const {
  double error_sum = 0.0;
  for (size_t i = 0; i < phase_data.size( ); ++i) {
    double fp = 2 * M_PI * log(primes[i]);
    double chi = (i % 2 == 0 ? 1 : −1) * log(primes[i]);
    double theta = fp * time + chi * pos;
    double actual_phase = std::arg(phase_data[i]);
    error_sum += std::abs(actual_phase − theta);
  }
  return 1.0 / (1.0 + error_sum); // Normalized phase-lock alignment
}
double PSRE::getC_n( ) const {
  double peak_sum = 0.0;
  double total_sum = 0.0;
  for (size_t i = 0; i < phase_data.size( ); ++i) {
    double mag = std::norm(phase_data[i]);
    total_sum += mag;
    if (i % 2 == 0) peak_sum += mag; // Treat even-indexed harmonics as coherence anchors
  }
  return (total_sum > 0) ? peak_sum / total_sum : 0.0;
}
bool PSRE::isIgnitionReady( ) const {
  return getC_n( ) >= c_n_cutoff;
}
void PSRE::phaseSweep(double t_start, double t_end, double pos) {
  for (double t = t_start; t < t_end; t += 0.01) {
    double pas = getPAS(t, pos);
    if (pas > 0.95) {
      // In a live system, trigger resonance capture
      break;
    }
  }
}
```

TABLE 15
Example of Illustrative training code for artificial intelligence
applications using a prime-encoded coherence grid.

```
Function train_codes_agi(grid, primes, timesteps, dt):
  n = grid.size
  For t from 0 to timesteps − 1:
    # Nonlinear structured resonance evolution
    For i from 0 to n − 1:
      f_p_k = 2 * PI * log(primes[i])
      χ_p_k = (−1) \hat{ } i * log(primes[i])
      θ_p_k = f_p_k * (t * dt) + χ_p_k * i
      grid[i] += dt * (j * (laplacian(grid[i]) + abs(grid[i])\hat{ }2 * grid[i])) # j = sqrt(−1)
    # Phase-lock feedback (Δθ_p correction)
    For i from 0 to n − 1:
      f_p_k = 2 * PI * log(primes[i])
      χ_p_k = (−1) \hat{ } i * log(primes[i])
      θ_p_k = f_p_k * (t * dt) + χ_p_k * i
      error = arg(grid[i]) − θ_p_k
      If abs(error) > 0.1:
        grid[i] *= exp(−j * 0.01 * error)
  Return grid
```

TABLE 16
Example code for implementing artificial intelligence functionality.

```
#include “PSRE.h”
#include “ResonanceData.h”
#include <string>
#include <vector>
#include <complex>
class CODES_AGI {
private:
  PSRE engine;
  ResonanceData data;
  std::vector<std::string> vocabulary;
public:
  CODES_AGI(const std::vector<double>& input, const std::vector<int>& primes,
        const std::vector<std::string>& vocab) :
    engine(input, primes), data(input, primes), vocabulary(vocab) { }
  std::string reason(double t, double x) {
    engine.lockPhases(t, x); // Lock phase evolution
    data.phaseAlign(t, x); // Align data resonance
    double coherence = engine.getC_n( ); // Updated from getCΨ( )
    if (coherence <= 1.0) return “Phase misalignment detected.”;
    std::vector<std::complex<double>> result = data.getData( );
    std::string output = “”;
    for (size_t i = 0; i < result.size( ); ++i) {
      if (std::norm(result[i]) > 0.5) { // Coherence threshold
        size_t vocab_idx = i % vocabulary.size( );
        output += vocabulary[vocab_idx] + “ ”;
      }
    }
    return output;
  }
};
// Usage Example
int main( ) {
  std::vector<int> primes = {2, 3, 5, 7, 11};
  std::vector<double> input ={1, 0, 1, 0, 1}; // Example for “What”
  std::vector<std::string> vocab = {“What”, “is”, “the”, “meaning”, “of”, “life”};
  CODES_AGI agi(input, primes, vocab);
  std::string response = agi.reason(0.5, 0.0);
  return 0;
}
```

Other organizations are also possible, and could be used without undue experimentation by those of skill in the art to implement aspects of the disclosed technology. Accordingly, the examples of variations on the organization of FIG. 17, like the organization of FIG. 17 itself, should be understood as being illustrative only, and not limiting.

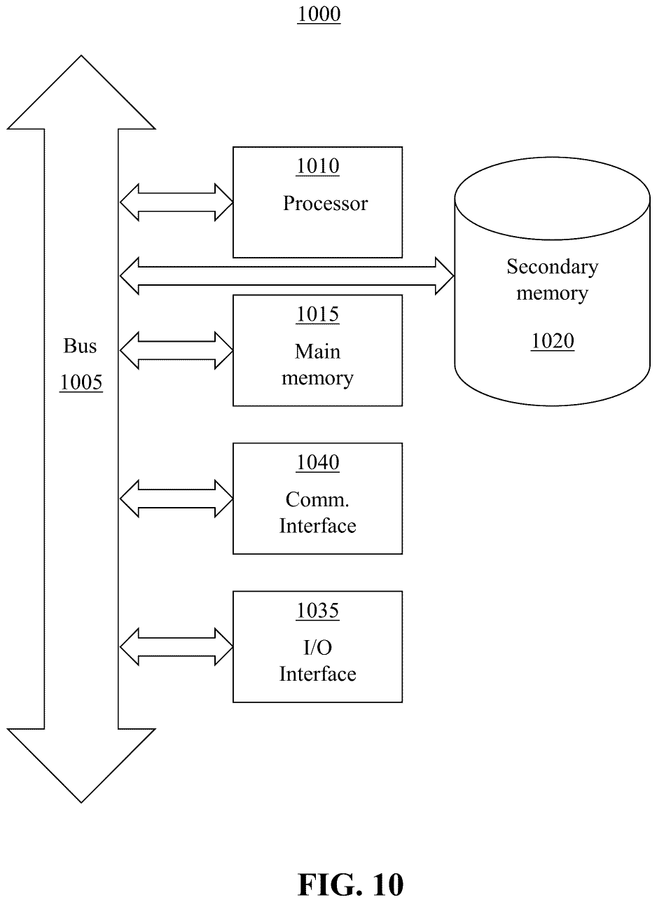

Just as variations are possible in specific steps which may be performed when practicing aspects of the disclosed technology, variations are also possible in hardware systems which may be used in its implementation. For instance, in some cases, the disclosed technology may be implemented using a processing module such as shown in FIG. 10, which is a block diagram illustrating an example computing apparatus 1000 that may be used in connection with various embodiments described herein. Computing apparatus 1000 can be a server or any conventional personal computer, or any other processor-enabled device that is capable of wired or wireless data communication. Other computing apparatus, systems and/or architectures may be also used, including devices that are not capable of wired or wireless data communication, as will be clear to those skilled in the art.

Computing apparatus 1000 preferably includes one or more processors, such as processor 1010. The processor 1010 may be for example a central processing unit (CPU), graphics processing unit (GPU), tensor processing unit (TPU) or arrays or combinations thereof such as CPU and TPU combinations or CPU and GPU combinations. Additional processors may be provided, such as an auxiliary processor to manage input/output, an auxiliary processor to perform floating point mathematical operations (e.g. a TPU), a special-purpose microprocessor having an architecture suitable for fast execution of signal processing algorithms (e.g., digital signal processor, image processor), a slave processor subordinate to the main processing system (e.g., back-end processor), an additional microprocessor or controller for dual or multiple processor systems, or a coprocessor. Such auxiliary processors may be discrete processors or may be integrated with the processor 1010. Examples of CPUs which may be used with computing apparatus 1000 are, the Pentium processor, Core i7 processor, and Xeon processor, all of which are available from Intel Corporation of Santa Clara, Calif. An example GPU which may be used with computing apparatus 1000 is Tesla K80 GPU of Nvidia Corporation, Santa Clara, Calif.

Processor 1010 is connected to a communication bus 1005. Communication bus 1005 may include a data channel for facilitating information transfer between storage and other peripheral components of computing apparatus 1000. Communication bus 1005 further may provide a set of signals used for communication with processor 1010, including a data bus, address bus, and control bus (not shown). Communication bus 1005 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Computing apparatus 1000 preferably includes a main memory 1015 and may also include a secondary memory 1020. The computer software or data stored on the secondary memory 1020 may be read into computing apparatus 1000 for execution by processor 1010, and main memory 1015 may provide storage of instructions and data for programs executing on processor 1010, such programs implementing processes such as discussed above. It should be understood that computer readable program instructions stored in the memory and executed by processor 1010 may be assembler instructions, instruction-set-architecture (ISA) instructions, machine instructions, machine dependent instructions, microcode, firmware instructions, state-setting data, configuration data for integrated circuitry, or either source code or object code written in and/or compiled from any combination of one or more programming languages, including without limitation Smalltalk, C/C++, Java, JavaScript, Perl, Visual Basic, .NET, and the like. Main memory 1015 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Computing apparatus 1000 may include a communication interface 1040. Communication interface 1040 allows software and data to be transferred between computing apparatus 1000 and external devices (e.g. printers), networks, or other information sources. For example, computer software or executable code may be transferred to computing apparatus 1000 from a network server via communication interface 1040. Examples of communication interface 1040 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing with a network or another computing device. Communication interface 1040 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Computer-executable code (i.e., computer programs or software) is stored in main memory 1015 and/or the secondary memory 1020. Computer programs can also be received via communication interface 1040 and stored in main memory 1015 and/or secondary memory 1020. Such computer programs, when executed, enable computing apparatus 1000 to perform the various functions of the disclosed embodiments as described elsewhere herein.

I/O interface 1035 provides an interface between one or more components of computing apparatus 1000 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

Various embodiments may also be implemented primarily in hardware using, for example, components such as application specific integrated circuits (ASICs), programmable logic arrays (PLA), or field programmable gate arrays (FPGAs) or hybrid architectures supporting PAS field propagation and Ao tracking. Implementation of a hardware state machine capable of performing the functions described herein will also be apparent to those skilled in the relevant art. It is possible that a hardware system which performed processing such as described herein may be located remotely from a user who would interact with the system (e.g., the disclosed technology could be used to provide API access to an artificial intelligence system on a software as a service basis). However, it is also possible that the disclosed technology may run entirely on a system which is local to its end user, with the deterministic nature of the disclosed technology being used to improve efficiency such that results which may only have been feasible previously using remote servers (or they were possible at all) may be provided by a local system. For example, benchmark tests using a Jetson Orin NX module from NVIDIA corporation and a coherence-optimized inference kernel demonstrated that a resonance field could be stabilized and evaluated using less than 5 W power while maintaining real-time phase alignment scoring (PAS≥0.91) across sequences of 128 anchors. These results validate the feasibility of local execution for coherence-driven inference without requiring stochastic sampling or external model queries. For comparison, a conventional convolutional neural network (CNN) trained on the MNIST dataset to achieve >99% digit classification accuracy required approximately 12-15 W average power during inference on the same Jetson Orin NX hardware, while the structured resonance system achieved stable PAS ≥0.91 on similarly complex recognition tasks using less than 5 W—demonstrating a ~2.5× improvement in energy efficiency under comparable accuracy conditions, without stochastic sampling or external model access.

It should be understood that, while this disclosure has focused on implementations which apply the disclosed technology to artificial intelligence, aspects of the disclosed technology may also be used for other types of data processing tasks. For example, in some cases, an operating system scheduler may use the disclosed technology to ensure system integrity by executing tasks only when phase alignment and global coherence thresholds are satisfied. This may be done, for instance, by treating tasks to be executed as inputs to be processed using a structured resonance field (e.g., converting an application to a waveform by converting tokens in the application's executable code into waves for processing). Exemplary code for implementing such a scheduler is provided below in table 17.

TABLE 17
Exemplary coherence governed task scheduler implementation code.

```
// PhaseOS.cpp - Coherence-Locked Execution Scheduler (Implementation)
#include “PhaseOS.h”
PhaseOS::PhaseOS(PSRE* engine, double pas_t, double cn_t)
  : coherence_engine(engine),
    pas_threshold(pas_t),
    cn_threshold(cn_t) { }
bool PhaseOS:isLegalPhase(double time, double pos) const {
  double local_pas = coherence_engine->getPAS(time, pos);
  double global_cn = coherence_engine->getC_n( ); // Renamed from getCΨ
  return (local_pas >= pas_threshold) && (global_cn >= cn_threshold);
}
void PhaseOS::scheduleIfCoherent(double time, double pos, const std::function<void( )>&
task) {
  if (isLegalPhase(time, pos)) {
    task( ); // Fire task only when phase coherence is legal both locally and globally
  } else {
    // Optionally reroute to ELF or log PAS/C_n degradation
  }
}
```

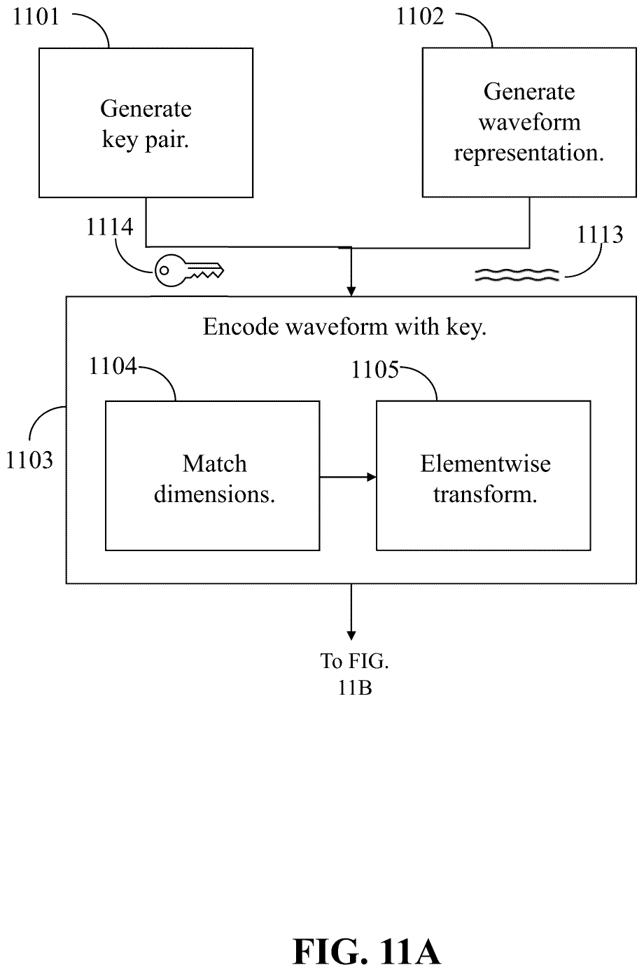

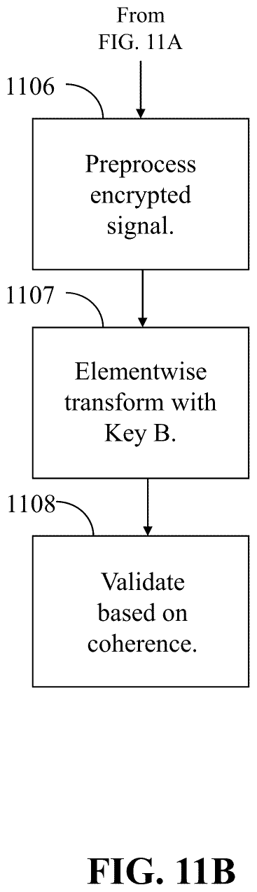

The disclosed technology may also be applied to computer security, such as by providing quantum resonance pair (QRP) encryption, which may be used for purposes such as preventing unauthorized memory accesses. A flowchart illustrating a method through which this may be implemented is provided in FIGS. 11A-11B. In that method, initially, a pair of keys is generated 1101. This may be done by generating frequency and chirality shifts from a set of prime integers (e.g., a group of between 49 and 1024 non-repeating prime numbers, which may be provided by a user or may be built in as default information) and an initial resonance anchor (which, as with the sets of prime integers, may be provided by a user, or may have a built in default value) and then converting them to a complex representation, thereby generating two complex key vectors, which may be referred to herein for convenience as Key A and Key B. Formally, this may be expressed with equations 33 and 34, below:

$$Key A [ i ] = polar ( 1. , f + 2 π * log ( {p}_{i} ) + ( θ + log ( {p}_{i} ) ) ) \qquad Equation 33$$

$$Key B [ i ] = polar ( 1. , f + 2 π * log ( {p}_{i} ) - ( θ + log ( {p}_{i} ) ) ) \qquad Equation 34$$

In those equations, KeyA[i] and KeyB[i] are the i^{th} elements in the vectors KeyA and KeyB, respectively. polar( ) is a function which generates a complex number from its polar coordinates, such as the std::polar( ) function in C++ from the <complex> header. pᵢ is the i^{th} element in the set of integer primes. f is the frequency of the initial resonance anchor (corresponding to pₖ from table 2), and 0 is the phase offset from the initial resonance anchor (corresponding to Δφₖ from table 2).

In addition to generating 1101 a pair of keys, the encryption method illustrated in FIG. 11A may also include generating 1102 a waveform representation of an input signal, such as through approaches described previously in the context of FIG. 2 for breaking down an input into constituent elements (e.g., tokens) and then defining wave representations (e.g., resonance anchors) for each of those tokens. The waveform representation 1113 can then be encoded 1103 using Key A 1114 from the key pair. This may be seen as starting with a dimension matching 1104 phase, in which the size of the waveform representation 1113 is matched to that of Key A 1114. For example, if the waveform representation 1113 included m waves (e.g., it was a combination of waves for m individual tokens) and the vector Key A 1114 included n elements, with n>m, then Key A may be resized to only have m elements, such as by trimming the n-m elements of Key A 1114 representing the n-m highest value primes in the original set of prime integers. Similarly, if the length of vector Key A 1114 is less than that of the wave representation 1113 (i.e., n<m), then additional elements may be added to vector Key A 1114 (e.g., additional elements for prime numbers not in the original set of prime numbers) to pad it such that its length would be the same as that for the wave representation 1113. It is also possible that the wave representations 1113 may be modified as part of the dimension matching 1104. For example, in some cases, if there were more elements in the wave representation 1113 than in the vector Key A 1114, the wave representation may be subdivided into two or more separate wave representations, each of which has fewer elements than the original 1113. Once the dimension matching 1104 was complete, an elementwise transform may be applied 1105, in which each element of the wave representation is transformed based on its corresponding element in Key A (e.g., the k^{th} element in the dimension matched wave representation may be multiplied by e\hat{ }(i*θₖ) where i is the square root of negative 1, and θₖ is the phase of the k^{th} element in dimension matched Key A). The transformed (encrypted) wave representation may then be transmitted, or stored in a secure location for future processing (e.g., decryption).

Turning next to FIG. 11B, that figure illustrates how an encrypted signal (e.g., a wave representation 1113 encrypted as described in the context of FIG. 11A) can be decrypted and validated using the disclosed technology. As shown in FIG. 11B, this may begin with performing one or more preprocessing 1106 operations on the encrypted signal, such as by phase inverting it (e.g., multiplying the phase of each element in the encrypted signal by −1). The preprocessed signal may then be subjected to an elementwise transform 1107 with Key B mirroring the transform 1105 with Key A from FIG. 11A. For example, if the encrypting transform 1105 of FIG. 11A is multiplication of each element in the dimension matched wave representation by e\hat{ }(i*θₖ), then the elementwise transform 1107 with Key B may be multiplying each element in the encrypted wave representation by e\hat{ }(i*θ_{B}), where i is the square root of negative 1, and θ_{B} is the phase of the corresponding element in Key B. Finally, the decrypted signal can be validated 1108, such as by inserting the decrypted elements of the signal into a resonance field populated using the original input signal, followed by identifying and evaluating coherent peaks in that field using techniques such as described previously in the context of FIGS. 3-9. If those peaks satisfied a coherence requirement included in the relevant implementation (e.g., having a phase alignment score of greater than a threshold such as 0.91), then the signal may be accepted. Otherwise, it may be rejected or flagged as failing validation (e.g., a malicious access attempt).

As an illustration of a potential application of QRP encryption, in some cases approaches such as described above may be used in implementing a secure memory subsystem, which may be referred to herein as echo field memory (EFM) which acts as a selective coherence buffer that stores encrypted resonance vectors only when phase alignment exceeds a system-defined memory threshold. Retrieval of information from echo field memory would involve a QRP validation sequence, and if the information cannot be validated, the system may either collapse the stored signal to null or initiate echo recovery logic. EFM may thus function as both a memory system and a coherence integrity validator. This can be used to ensure that memory access is: 1) Resonance-gated, 2) Phase-locked to alignment (PAS), 3) Encrypted via chirally encoded quantum pairs (QRP), 4) Auto-recursive via echo pattern recovery (e.g., remediation as described in the context of FIG. 8) if coherence is disrupted. This forms a secure memory+retrieval layer and defends against unauthorized access. Additionally, because the inference logic can be encoded using prime-based chirality mappings and coherence-gated field structures, reverse engineering via traditional circuit analysis or model inspection is functionally infeasible. This results in a form of intrinsic obfuscation where the internal structure cannot be reproduced or replicated without origin-phase resonance knowledge, thereby protecting the system even if physical access is obtained.

Examples of code which may be used in implementing QRP encryption in the context of EFM are provided below in tables 18-20.

TABLE 18
Example of Declaration of the QRP class for chirally encoded encryption
via prime-locked harmonic pairs, which defines both the Quantum Resonance
Pair (QRP) encryption layer and the Echo Field Memory (EFM) subsystem.

```
// QRP.h - Quantum Resonance Pair Encryption (Declaration)
#ifndef QRP_H
#define QRP_H
#include <vector>
#include <complex>
class QRP {
private:
  std::vector<std::complex<double>> key_a;
  std::vector<std::complex<double>> key_b;
  double prime_phase_anchor;
public:
  QRP(const std::vector<int>& primes, double phi_anchor = 0.01);
  std::vector<std::complex<double>> encrypt(const std::vector<std::complex<double>>&
raw_signal);
  bool verify(const std::vector<std::complex<double>>& encrypted_signal);
};
#endif
```

TABLE 19
Example of Implementation of QRP, performing dual-phase encryption +
validation using imaginary-symmetry damping, wherein the verification
logic checks that the imaginary components of the encrypted signal
are sufficiently suppressed (i.e., within a bounded epsilon of zero).

```
// QRP.cpp - Quantum Resonance Pair Encryption (Implementation)
#include “QRP.h”
#include <cmath>
QRP::QRP(const std::vector<int>& primes, double phi_anchor)
  : prime_phase_anchor(phi_anchor) {
  for (int p : primes) {
    double f = 2 * M_PI * log(p_k);
    double chi = log(p_k);
    key_a.emplace_back(std::polar(1.0, f + chi));
    key_b.emplace_back(std::polar(1.0, f − chi));
  }
}
std::vector<std::complex<double>> QRP::encrypt(const std::vector<std::complex<double>>&
raw_signal) {
  std::vector<std::complex<double>> encoded(raw_signal.size( ));
  for (size_t i = 0; i < raw_signal.size( ); ++i) {
    encoded[i] = raw_signal[i] * std::conj(key_a[i % key_a.size( )]) * key_b[i %
key_b.size( )];
  }
  return encoded;
}
bool QRP::verify(const std::vector<std::complex<double>>& encrypted_signal) {
  for (size_t i = 0; i < encrypted_signal.size( ); ++i) {
    if (std::abs(std::imag(encrypted_signal[i])) > prime_phase_anchor) return false;
  }
  return true;
}
```

TABLE 20
Example of Partial implementation of EFM (Echo Field Memory),
with resonance-based encryption, alignment gating, and echo
collapse response in which data is gated through a quantum
resonance pair and written only when an alignment threshold
based on a phase alignment score, and where retrieval is
validated by symmetry coherence under QRP structure.

```
// EFM.cpp - Echo Field Memory (Implementation Snippet)
#include <vector>
#include <complex>
#include “QRP.h”
class EFM {
private:
  std::vector<std::complex<double>> storage;
  QRP encryption_layer;
  double pas_memory_cutoff;
public:
  EFM(const std::vector<int>& primes, double pas_cut = 0.91)
    : encryption_layer(primes), pas_memory_cutoff(pas_cut) { }
  void storeIfPASLocked(const std::vector<std::complex<double>>& raw,
        double pas_val) {
    if (pas_val >= pas_memory_cutoff) {
      storage = encryption_layer.encrypt(raw);
    }
  }
  std::vector<std::complex<double>> recallIfVerified( ) {
    if (encryption_layer.verify(storage)) {
      return storage;
    } else {
      // Echo recovery (via REM) or signal collapse
      return std::vector<std::complex<double>>(storage.size( ), {0, 0});
    }
  }
};
```

The disclosed technology may also be applied to identifying underlying patterns and anomalies in real world data, such as identifying gravitational anomalies based on gravitational wave signal data. To illustrate, consider the case of identifying gravitational anomalies in the data gathered by the laser interferometer gravitational wave observatory (LIGO). In an implementation, the disclosed technology was used to analyze raw data from the Hanaford LIGO detector (the “LIGO H1 data”) in the form of strain measurements timestamped with global positioning system (GPS) times ranging from GPS 1242442965.779297-1242442968.220459. In this analysis, a sliding window approach was used, in which the LIGO H1 data was segmented into ~1.2 second time slices, and each slice was decomposed via continuous wavelet transformation into a set of component wavelets across the 32-2048 Hz frequency band (i.e., the frequency band matching the primary sensitivity range of the Hanaford LIGO detector). The four highest amplitude wavelets as identified using fast Fourier transformation and localized with Hilbert-transform derived phases were then converted into phase anchors and used to populate a resonance field with dimensions representing chirality, frequency index (e.g., attribute pₖ from table 2), phase delta, and time. The resonance fields for each slice were then updated as described previously in the context of FIG. 6, with updates to the resonance anchors' phase offsets being performed by phase locking using equation 5. Ultimately, the resonance field corresponding to the time slice centered on GPS time 1242442967.256348 was found to be coherent, with a PAS value (calculated according to equation 9) of greater than 0.9, and a rate of change in PAS value across updates of slightly less than 2*10-38. The center-point of that time slice was identified as a peak, and the time coordinate (i.e., 1242442967.256348), which corresponded to the GW190521 event (a gravitational wave signal resulting from the merger of black holes) was provided as the output of the analysis, thereby demonstrating the potential efficacy of the disclosed technology for analyzing and identifying underlying patterns and anomalies in massive real world datasets. Exemplary code for the above-described LIGO data analysis is provided below in tables 21-24.

TABLE 21
extract_data.py - Extracts raw gravitational wave
strain data from an HDF5 file (e.g., LIGO H1), preparing
time-domain input for structured resonance encoding.

```
# extract_data.py - HDF5 Strain Data Extraction
import h5py
import numpy as np
def extract_h1_data(file_path, gps_start, gps_end, sample_rate=4000):
  “““
  Extracts strain data from an HDF5 file for the given GPS time range.
  Parameters:
  - file_path (str): Path to the HDF5 file.
  - gps_start (float): Start GPS time.
  - gps_end (float): End GPS time.
  - sample_rate (int): Sampling rate in Hz.
  Returns:
  - np.array: Extracted strain data.
  - np.array: Corresponding time values.
  ”””
  with h5py.File(file_path, ‘r’) as f:
    strain = f[‘strain’][‘H1’][:]
    time = np.linspace(gps_start, gps_end, num=len(strain))
  return time, strain
# Example usage
gps_start = 1242442965.779297
gps_end = 1242442968.220459
file_path = “H1_LIGO_strain.hdf5”
time_data, strain_data = extract_h1_data(file_path, gps_start,
gps_end)
```

TABLE 22
process_codes.py - Encodes raw signal using prime-structured resonance and
computes the coherence confidence score (CCS) to evaluate alignment fidelity.

```
# process_codes.py - Prime-Resonance Encoding and CCS Computation
import numpy as np
def prime_phase_encoding(strain, primes=[2, 3, 5, 7]):
  “““
  Encodes strain data into structured resonance using prime harmonics.
  Parameters:
  - strain (np.array): Input strain data.
  - primes (list): Prime frequency bases.
  Returns:
  - np.array: Prime-encoded resonance signal.
  ”””
  encoded_signal = np.zeros_like(strain, dtype=complex)
  for p_k in primes:
    phase_factor = np.exp(1j * (2 * np.pi * np.log(p_k) * np.arange(len(strain))))
    encoded_signal += (1 / p_k) * strain * phase_factor
  return encoded_signal
def compute_ccs(encoded_signal):
  “““
  Calculates coherence confidence score (CCS) for structured resonance alignment.
  Parameters:
  - encoded_signal (np.array): Complex encoded signal.
  Returns:
  - float: Coherence score value.
  ”””
  return np.abs(np.sum(encoded_signal)) ** 2 / np.sum(np.abs(encoded_signal) ** 2)
# Apply resonance encoding and compute coherence
encoded_strain = prime_phase_encoding(strain_data)
ccs_score = compute_ccs(encoded_strain)
print(f“Coherence Confidence Score (CCS): {ccs_score:.6e}”)
```

TABLE 23
plot_ccs.py - Visualizes resonance magnitude over time with
markers for signal alignment (e.g., gravitational wave detection).

```
# plot_ccs.py - Visualization of Structured Resonance Fields
import matplotlib.pyplot as plt
def plot_resonance(time, encoded_signal, title=“Prime-Resonance Signal”):
  “““
  Plots the magnitude of a structured resonance signal.
  Parameters:
  - time (np.array): Time vector.
  - encoded_signal (np.array): Resonance signal.
  - title (str): Plot label.
  ”””
  plt.figure(figsize=(10, 5))
  plt.plot(time, np.abs(encoded_signal), label=“Resonance Signal”, color=“blue”)
  plt.axvline(x=1242442967.256348, color=‘red’, linestyle=‘--’, label=“GW190521 Event”)
  plt.xlabel(“GPS Time (s)”)
  plt.ylabel(“Signal Amplitude”)
  plt.title(title)
  plt.legend( )
  plt.show( )
# Plot the encoded resonance signal
plot_resonance(time_data, encoded_strain)
```

TABLE 24
Example of lockPhases.py - Implements real-time phase correction for structured
resonance convergence, refining signal alignment via Δφ feedback.

```
# lockPhases.py - Feedback Loop for Resonance Stabilization
def lockPhases(resonance_data, target_coherence=1.0):
  “““
  Adjusts local phases to enforce structured resonance coherence.
  Parameters:
  - resonance_data (dict): Could contain ‘phases’ and corresponding ‘CCS’ values.
  - target_coherence (float): Desired coherence threshold.
  Returns:
  - dict: Phase-adjusted resonance data.
  ”””
  for i, phase in enumerate(resonance_data[‘phases’]):
    error = target_coherence − resonance_data[‘CCS’][i]
    resonance_data[‘phases’][i] += 0.01 * np.angle(error)
  return resonance_data
```

The disclosed technology may also be used in cognitive tasks, such as providing brain interfaces and/or neurological stimulation. For example, EEG or fMRI signal data may be treated as time-series waveforms or converted to such via interpolation or transformation (e.g., via discrete Fourier or wavelet transform). These waveforms can then be used to populate a resonance field and, once the field is in a coherent state, its peak(s) may be used to provide biofeedback or other outputs for the task at hand. For example, in a case where an anchor corresponding to a fMRI signal indicating activation of a brain region corresponding to a particular emotion was identified as a peak, that brain region could be treated as an output for controlling a neurological feedback device, such as augmented reality equipment. For instance, if the disclosed technology was being used in the context of an augmented reality horror video game, a fear peak (which may be indicated by identification of an anchor corresponding to Amygdala activation as a peak in a coherent resonance field) may be treated as a trigger to provide inputs which would be likely to increase the user's anxiety (e.g., desaturating the color palette, playing unexpected sound effects, etc.). Similarly, if a peak output waveform had a wavelength corresponding to a particular type of brain wave this could be treated as an output for triggering a corresponding type of input for a user (e.g., an output waveform with a frequency consistent with gamma waves could trigger presentation of a puzzle or other cognitive task, while an output waveform with a frequency consistent with theta waves could trigger a reduction in stimulation via noise reduction or other mechanisms). Other approaches, such as variations in which the disclosed technology is implemented to provide either reinforcing or contrasting feedback based on chirality (e.g., a peak anchor corresponding to amygdala activation could trigger anxiety inducing feedback if the anchor had right chirality, or anxiety reducing feedback if the anchor had left chirality) are also possible, and could be implemented without undue experimentation by those of skill in the art based on this disclosure. Accordingly, the above examples of how the disclosed technology could be applied to cognitive tasks should be understood as being illustrative only, and should not be treated as limiting.

While various examples of how the disclosed technology may be implemented have been set forth herein, it should be understood that those examples are intended to be illustrative only, and that they should not be treated as implying limits on the protection provided by this document or any related document. Instead, the protection provided by such document should be defined by its claims, when the terms in those claims which are defined under an “Explicit Definitions” heading are giving their explicit definitions, and the terms which are not so defined are given their broadest reasonable interpretation as provided by a general purpose dictionary.

### EXPLICIT DEFINITIONS

It should be understood that, when appearing in the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, when appearing in the claims, the term “set” should be understood as one or more things which are grouped together.

1. A method, comprising:
deriving one or more prime resonance anchors corresponding to an input waveform;
using the one or more prime resonance anchors to generate one or more coherent peaks of a prime encoded resonance field; and
providing a result based on the one or more coherent peaks.

2. The method of claim 1, wherein:
the method comprises:
converting an input into a set of tokens;
obtaining a set of waveforms, wherein the set of waveforms comprises a waveform for each token from the set of tokens; and
combining the set of waveforms into a composite waveform; and
the input waveform is the composite waveform.

3. The method of claim 2, wherein combining the set of waveforms into the composite waveform comprises generating a normalized sum of the set of waveforms.

4. The method of claim 1, wherein the method comprises obtaining the input waveform based on applying a frequency space transformation to a non-waveform input.

5. The method of claim 4, wherein the frequency space transformation is a Fourier transform.

6. The method of claim 4, wherein:
the non-waveform input is an embedding; and
the frequency space transformation is harmonic principal projection.

7. The method of claim 1, wherein:
each of the one or more prime resonance anchors corresponds to a constituent waveform of the input waveform; and
deriving one or more prime resonance anchors corresponding to the input waveform comprises, for each of the one or more prime resonance anchors, bring a phase difference between a prime waveform for that prime resonance anchor and the corresponding constituent waveform for that prime resonance anchor into conformity with a phase alignment threshold.

8. The method of claim 1, wherein using the one or more prime resonance anchors to generate one or more coherent peaks of the prime encoded resonance field comprises:
bringing the prime encoded resonance field into a coherent state by iteratively adjusting a plurality of location specific values in that field; and
identifying the one or more coherent peaks in the coherent state prime encoded resonance field.

9. The method of claim 8, wherein:
the plurality of location specific values comprises, for each prime resonance anchor from the one or more prime resonance anchors corresponding to the input waveform, a phase offset value for that anchor; and
iteratively adjusting the plurality of location specific values comprises, on each iteration from a plurality of iterations, for each location specific value from the plurality of location specific values, adjusting that location specific value based on phase offset values for neighboring locations in the prime encoded resonance field.

10. The method of claim 8, wherein:
calculating, for each prime resonance anchor from a plurality of prime resonance anchors, a coherence value based on an adjusted location specific value corresponding to that prime resonance anchor; and
identifying at least one of the plurality of prime resonance anchors as a coherent peak based on filtering the plurality of prime resonance anchors using the coherence values of the plurality of prime resonance anchors.

11. The method of claim 10, wherein:
each prime resonance anchor from the plurality of prime resonance anchors has a chirality value from a plurality of chirality values;
for each chirality value from the plurality of chirality values, the one or more coherent peaks of the prime encoded resonance field comprise a prime resonance anchor having that chirality value.

12. The method of claim 1, wherein:
generating one or more coherent peaks of the prime encoded resonance field comprises generating a plurality of coherent peaks; and
providing the result based on the one or more coherent peaks comprises:
obtaining an output waveform based on the plurality of coherent peaks; and
converting the output waveform to the result.

13. The method of claim 12, wherein converting the output waveform to the result comprises obtaining the result from a lookup table using the output waveform.

14. The method of claim 1, wherein the method comprises:
generating a plurality of partial results corresponding to the input waveform; and
evaluating the plurality of partial results as a sequence of partial results.

15. The method of claim 14, wherein evaluating the plurality of partial results as a sequence comprises determining a phase alignment based on differences between phases for the partial results in the sequence of partial results and an average phase for the prime encoded resonance field.

16. The method of claim 14, wherein evaluating the plurality of partial results as a sequence comprises determining a weighted global emission score using a coherence weight and a phase for each of the plurality of partial results.

17. The method of claim 16, wherein the method comprises, for each partial result from the plurality of partial results, the coherence weight for that partial result is based on:
a phase alignment between that partial result and neighboring values in the prime encoded resonance field;
a historical alignment for that partial result; and
structural harmony between that partial result and the prime encoded resonance field.

18. The method of claim 14, wherein evaluating the plurality of partial results as a sequence comprises applying a structural integrity filter based on, for each partial result from the plurality of partial results:
a phase delta across adjacent partial results in the sequence; and
a memory match coefficient for that partial result.

19. The method of claim 14, wherein the method comprises remediating the sequence of partial results by performing acts comprising re-performing the generation of one or more coherent peaks of the prime encoded resonance field.

20. The method of claim 1, wherein:
the input waveform is a waveform for a natural language prompt; and
the result is a natural language response to the natural language prompt.
